(19) United States
(12) Patent Application Publication
(10) Pub. No.: US 2006/0155907 A1
(43) Pub. Date: Jul. 13, 2006

(54) Multiprocessor system

(75) Inventors: Yoshimasa Yoshida, Beijing (CN); Mitsuya Nakahara, Ibaraki-shi (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/300,322

(22) Filed: Dec. 15, 2005

(30) Foreign Application Priority Data
Dec. 16, 2004 (JP) 2004-363753

(51) Int. Cl. G06F 13/24; H04L 12/56

(52) U.S. Cl. 710/260

(57) ABSTRACT

A multiprocessor system from which redundancy relating to data assurance at the time of data communication between processing sections is removed. At the time of data communication between a network processing section (101) and a real-time processing section (201), exclusive control of a shared memory is performed by means of only an operation to output a transmission completion interrupt signal from the network processing section (101) on the transmitting side to the real-time processing section (201) on the receiving side and an operation to detect the transmission completion interrupt input by the real-time processing section (201) on the receiving side, and data assurance against data change and data loss is made by means of only TCP/IP protocol stack software (213).

### FIELD OF THE INVENTION

The present invention relates to a multiprocessor system having a plurality of processing sections (processors).

### BACKGROUND OF THE INVENTION

A conventional multiprocessor system having a network processing section and a real-time processing section will be described below with reference to FIGS. 19 to 27.

FIG. 19 is a block diagram of a conventional multiprocessor system having a network processing section and a real-time processing section.

Referring to FIG. 19, the network processing section 101 is a processing section for implementation of a communication function and other functions of the multiprocessor system 100. The network processing section 101 is connected to an external network such as the Internet and executes communication processing. For example, the processing section 101 downloads audio-visual (AV) data or the like from a website or the like on the Internet.

The real-time processing section 201 is a processing section for implementation of an AV function (a function to take in audio-visual data), a display function and other functions of the multiprocessor system 100. The real-time processing section 201 performs, for example, processing for decoding AV data obtained from an external network by the network processing section 101, and display processing.

A central processing unit (CPU) 102 for network processing controls the entire network processing section 101. A CPU 202 for real-time processing controls the entire real-time processing section 201.

A main memory 103 stores pieces of software used to control the network processing section 101. A main memory 203 stores pieces of software used to control the real-time processing section 201.

The CPU 102 controls each of various kinds of processing by reading out the corresponding one of the pieces of software stored in the main memory 103. The CPU 202 controls each of various kinds of processing by reading out the corresponding one of the pieces of software stored in the main memory 203.

An operating system (OS) 104 is a piece of software for enabling the CPU 102 to control the network processing section 101. The OS 104 is stored in the main memory 103. An operating system (OS) 204 is a piece of software for enabling the CPU 202 to control the real-time processing section 201. The OS 204 is stored in the main memory 203.

The OS 104 is equipped with a TCP/IP protocol stack 113 for implementation of a communication procedure based on the TCP/IP protocol. The OS 204 is equipped with a TCP/IP protocol stack 213 for implementation of a communication procedure based on the TCP/IP protocol.

The network processing section 101 has a network interface 105 for connection between the network processing section 101 and an external network. The network interface is implemented, for example, in the form of an Ethernet® interface or the like.

The OS 104 is equipped with a network device driver 115, which controls the network interface 105 under the TCP/IP protocol stack 113. The network driver is implemented, for example, in the form of an Ethernet® device driver or the like.

A shared memory 301 temporarily stores data communicated between the network processing section 101 and the real-time processing section 201.

The network processing section 101, the real-time processing section 201 and the shared memory 301 are connected to each other by a bus interface 106 provided in the network processing section 101, a bus interface 206 provided in the real-time processing section 201 and a shared bus 302.

The shared bus 302 has an address/data line 311. The network processing section 101 makes data access to the shared memory 301 through the bus interface 106 and the address/data line 311. Similarly, the real-time processing section 201 makes data access to the shared memory 301 through the bus interface 206 and the address/data line 311.

The shared bus 302 has interrupt notice lines 314 to 317 through which interrupts are notified between the network processing section 101 and the real-time processing section 201.

The bus interface 106 has a transmission completion notice output/reception completion notice input device 116. The bus interface 206 has a transmission completion notice output/reception completion notice input device 217.

The transmission completion notice output/reception completion notice input device 116 outputs an interrupt signal to the interrupt notice line 314 and receives an input signal from the interrupt notice line 315 to produce an interrupt in the CPU 102.

The transmission completion notice output/reception completion notice input device 217 outputs an interrupt signal to the interrupt notice line 317 and receives an input signal from the interrupt notice line 316 to produce an interrupt in the CPU 202.

The bus interface 106 also has a transmission completion notice input/reception completion notice output device 117, which receives an input signal from the interrupt notice line 317 to produce an interrupt in the CPU 102, and outputs an interrupt signal to the interrupt notice line 316.

The bus interface 206 has a transmission completion notice input/reception completion notice output device 216, which receives an input signal from the interrupt notice line 314 to produce an interrupt in the CPU 202, and outputs an interrupt signal to the interrupt notice line 315.

The OS 104 is equipped with a virtual network device driver 114, which controls the bus interface 106 under the TCP/IP protocol stack 113 to control delivery of data to or from the TCP/IP protocol stack 113, data access to the shared memory 301 and interrupt signal input/output.

The OS-204 is equipped with a virtual network device driver 214, which controls the bus interface 206 under the TCP/IP protocol stack 213 to control delivery of data to or from the TCP/IP protocol stack 213, data access to the shared memory 301 and interrupt signal input/output.

The virtual network device driver is implemented, for example, in the form of a device driver equipped with the same I/F (function) as that of an Ethernet® device driver.

The operation of the thus-constructed conventional multiprocessor system 100 will be described with reference to FIGS. 20 to 25 by assuming that the network processing section 101 is on the data transmitting side while the real-time processing section 201 is on the data receiving side.

FIG. 20 shows the flow of the operation of the virtual network device driver 114 of the network processing section 101 on the transmitting side and the virtual network device driver 214 of the real-time processing section 201 on the receiving side. FIG. 21 shows a sequence of operations performed by the virtual network device driver 114 of the network processing section 101 on the transmitting side and the virtual network device driver 214 of the real-time processing section 201 on the receiving side. FIGS. 22 to 25 are diagrams for explaining the operation of the multiprocessor system 100.

In step S2001, the virtual network device driver 114 of the network processing section 101 on the transmitting side receives a transmission request from the TCP/IP protocol stack 113. In step S2002, upon receiving the request, the virtual network device driver 114 writes transmission data, which is received from the TCP/IP protocol stack 113, to the shared memory 301 via the bus interface 106 and the shared bus 302 (see (1) of FIG. 22).

After the completion of writing, the virtual network device driver 114 transmits, in step S2003, a transmission completion interrupt signal to the interrupt notice line 314 by controlling the transmission completion notice output/reception completion notice input device 116 (S-INT transmission). The transmission completion notice input/reception completion notice output device 216 of the real-time processing section 201 on the receiving side receives the transmission completion interrupt signal (r-INT reception) and then produces an interrupt in the CPU 202 by inputting a reception start interrupt signal to the CPU 202 to start the virtual network device driver 214 (see (2) of FIG. 23).

Upon reception of the reception start interrupt signal in step S2005, the virtual network device driver 214 reads out, in step 2006, the data written to the shared memory 301, via the shared bus 302 and the bus interface 206, and makes the TCP/IP protocol stack 213 process the data (see (3) of FIG. 24).

In step S2007 after the completion of reading, the virtual network device driver 214 controls the transmission completion notice input/reception completion notice output device 216 to output a reception completion interrupt signal to the interrupt notice line 315 (r-INT transmission) The transmission completion notice output/reception completion notice input device 116 of the network processing section 101 on the transmitting side receives the reception completion interrupt signal (S-INT reception) and thereafter produces an interrupt in the CPU 102 by inputting a transmission start interrupt signal to the CPU 102 (see (4) of FIG. 25).

When the transmission start interrupt signal is input in step S2004, the virtual network device driver 114 determines that transmission of data is completed and enters a state of awaiting a transmission request from the TCP/IP protocol stack 113.

In the conventional multiprocessor system, the above-described operation is repeatedly performed to transmit data from the network processing section 101 to the real-time processing section 201. For example, the above-described operation is repeatedly performed in the conventional multiprocessor system to transfer AV data downloaded from a website or the like to the real-time processing section 201 (see, for example, National Publication of International Patent Application No. 2001-524713).

Thus, in the conventional multiprocessor system, a shared memory is provided for transmission of data from the transmitting side to the receiving side, the processing section on the transmitting side writes to the shared memory transmission data, and the processing section on the receiving side reads out the data from the shared memory. Also, in the conventional multiprocessor system, exclusive control of the shared memory is performed by means of the operation to output a transmission completion interrupt signal from the transmitting side to the receiving side, the operation to detect the transmission completion interrupt input on the receiving side, the operation to output a reception completion interrupt signal from the receiving side to the transmitting side and the operation to detect the reception completion interrupt input from the transmitting side.

Another conventional multiprocessor system will be described.

FIG. 26 is a block diagram of another conventional multiprocessor system. Components corresponding to those described with reference to FIG. 19 are indicated by the same reference numerals, and the description for them will not be repeated. This multiprocessor system differs from the above-described conventional multiprocessor system in that a plurality of real-time processing sections are provided. The multiprocessor system will be described by way of example with respect to a case where two real-time processing sections A201a and B201b are provided.

In the multiprocessor system 100, a number of interrupt notice lines twice that in the multiprocessor system shown in FIG. 19 are provided for transmission of data from one network processing section 101 to the two real-time processing sections A201a and B201b. In the case where data is transmitted from the network processing section 101 to the real-time processing sections A201a and B201b, the virtual network driver 114 on the transmitting side determines the completion of transmission of the data after detecting all the signal inputs from transmission completion notice input/reception completion notice output devices 216a and 216b provided in the real-time processing sections A201a and B201b on the receiving side, and thereafter enters a state of awaiting a transmission request from the TCP/IP protocol stack 113.

The operation of the thus-constructed conventional multiprocessor system 100 will be described with reference to FIG. 27 by assuming that the network processing section 101 is on the data transmitting side while the real-time processing sections A201a and B201b are on the data receiving side. FIG. 27 shows the flow of the operation of the virtual network device driver 114 of the network processing section 101 on the transmitting side and virtual network device drivers 214a and 214b in the real-time processing sections A201a and B201b on the receiving side.

In step S2701, the virtual network device driver 114 of the network processing section 101 on the transmitting side receives a transmission request from the TCP/IP protocol stack 113. In step S2702, upon receiving the request, the virtual network device driver 114 writes transmission data, which is received from the TCP/IP protocol stack 113, to the shared memory 301 via the bus interface 106 and the shared bus 302.

After the completion of writing, the virtual network device driver 114 transmits, in step S2703, a transmission completion interrupt signal to each of the interrupt notice lines 314a and 314b by controlling the transmission completion notice output/reception completion notice input device 116.

Each of the transmission completion notice input/reception completion notice output devices 216a and 216b of the real-time processing sections A201a and B201b on the receiving side receives the transmission completion interrupt signal and then produces an interrupt in the CPU 202a or 202b by inputting a reception start interrupt signal to the CPU 202a or 202b to start the virtual network device driver 214a or 214b.

Upon reception of the reception start interrupt signal in step S2706, each of the virtual network device drivers 214a and 214b reads out, in step 2707, the data written to the shared memory 301, via the shared bus 302 and the bus interface 206a or 206b, and makes the TCP/IP protocol stack 213a or 213b process the data.

In step S2708 after the completion of reading, each of the virtual network device drivers 214a and 214b controls the transmission completion notice input/reception completion notice output device 216a or 216b to output a reception completion interrupt signal to the interrupt notice line 315a or 315b.

Each time the transmission completion notice output/reception completion notice input device 116 of the network processing section 101 on the transmitting side produces an interrupt in the CPU 102 each time it receives the reception completion interrupt signal from the transmission completion notice input/reception completion notice output device 216a or 216b.

The virtual network device driver 114 of the network processing section 101 on the transmitting side completes receiving each the reception completion interrupt signals from the real-time processing sections A201a and B201b in steps S2704 and 2705, it determines that transmission of data is completed and enters a state of awaiting a transmission request from the TCP/IP protocol stack 113.

In this conventional multiprocessor system 100, the above-described operation is repeatedly performed to transmit data from one network processing section 101 to two real-time processing sections A201a and B201b. For example, the above-described operation is repeatedly performed in this conventional multiprocessor system to transfer AV data downloaded from a website or the like to the real-time processing sections A201a and B201b.

Thus, in the conventional multiprocessor system in which 1:n (n=2 in the example shown in FIG. 26) data communication is performed between internal sections, the completion of transmission of data is determined only after detection of all of reception completion interrupt inputs from the processing sections on the receiving side, and a transition to a state of awaiting transmission request from the TCP/IP protocol stack 113 is thereafter made.

In the conventional multiprocessor system, as described above, (2×n) notice lines are provided for 1:n data communication between internal sections and exclusive control of a shared memory is performed by means of the operation to output a transmission completion interrupt signal from the transmitting side to the receiving side, the operation to detect the transmission completion interrupt input on the receiving side, the operation to output a reception completion interrupt signal from the receiving side to the transmitting side and the operation to detect the reception completion interrupt input from the transmitting side.

In the latter two of these shared memory exclusive control operations, i.e., the operation to output a reception completion interrupt signal from the receiving side to the transmitting side and the operation to detect the reception completion interrupt input from the transmitting side are performed for the purpose of preventing data in the shared memory from being overwritten with the next transmission data. That is, in the conventional multiprocessor system, the processing section on the transmitting side cannot write transmission data, before the completion of reading by the processing section on the receiving side, even if the readout operation of the processing section on the receiving side is delayed, thus achieving assurance of data against data change and data loss caused by data overwrite.

However, a mechanism for assurance of data against data change and data loss is originally incorporated in the TCP/IP protocol stack software loaded in each processing section in the system. The conventional multiprocessor system is provided with two data assurance mechanisms, i.e., the mechanism in the above-described shared memory exclusive control and the mechanism in the data processing section, and thus has a redundancy.

### DISCLOSURE OF THE INVENTION

In view of the above-described problem, an object of the present invention is to provide a multiprocessor system in which exclusive control of a shared memory at the time of data communication is performed by means of only an operation to output a transmission completion interrupt signal (a notice signal for notifying write to the shared memory of transmission data) from the transmitting side to the receiving side and an operation to detect the transmission completion interrupt input on the receiving side, in which data assurance against data change and data loss is made by means of only TCP/IP protocol stack software (protocol software), and from which redundancy relating to data assurance at the time of data communication between the processing sections is thereby removed.

To achieve the above-described object, according to the present invention, there is provided a multiprocessor system which includes a processing section which transmits data, a processing section which receives data, a shared bus connected between the processing sections, and a shared memory accessed from each processing section via the shared bus, in which multiprocessor system, at the time of data communication between the processing sections, the processing section on the transmitting side writes to the shared memory transmission data; the processing section on the receiving side reads out from the shared memory the transmission data; and exclusive control of the shared memory is performed by outputting, from the processing section on the transmitting side to the processing section on the receiving side, via the shared bus, a notice signal for notifying write to the shared memory of the transmission data, the processing section on the transmitting side having a notice signal output device which outputs the notice signal to the processing section on the receiving side, and a first memory device which stores first protocol software capable of execution of data communication between the processing sections and data assurance, and first device software for writing to the shared memory the transmission data received from the first protocol software and for executing output of the notice signal by the notice signal output device, the processing section on the receiving side having a notice signal input device which inputs the notice signal from the processing section on the transmitting side, and a second memory device which stores second protocol software capable of execution of data communication between the processing sections and data assurance, and second device software for executing readout from the shared memory of the transmission data, after the notice signal has been input by the notice signal input device, and for making the second protocol software process the read-out transmitted data, the shared bus having a notice line through which the notice signal is transmitted from the processing section on the transmitting side to the processing section on the receiving side at the time of data communication.

In the multiprocessor system in accordance with the present invention, the first device driver software provided in the processing section on the transmitting side may execute output of the notice signal to the processing section on the receiving side by the notice signal output device immediately after the completion of write to the shared memory of the transmission data.

In the multiprocessor system in accordance with the present invention, the first device driver software provided in the processing section on the transmitting side may execute output of the notice signal to the processing section on the receiving side by the notice signal output device immediately before write to the shared memory of the transmission data.

In the multiprocessor system in accordance with the present invention, the first device driver software provided in the processing section on the transmitting side may execute output of the notice signal to the processing section on the receiving side by the notice signal output device when a predetermined amount of written data is reached during write to the shared memory of the transmission data.

In the multiprocessor system in accordance with the present invention, the processing section on the transmitting side may further have a timer which notifies time out after a lapse of a predetermined time period, and the first device driver software provided may make the timer start measuring time after the completion of write to the shared memory of the transmission data, and may execute write to the shared memory of the next transmission data, after receiving the timeout notice from the timer.

In the multiprocessor system in accordance with the present invention, the shared memory may be provided at such a position that the speed of access to the shared memory from the processing section on the receiving side is higher than the speed of access to the shared memory from the processing section on the transmitting side.

In the multiprocessor system in accordance with the present invention, the shared memory may be included in the second memory device provided in the processing section on the receiving side or a third memory device provided in the processing section on the receiving side separately from the second memory device.

In the multiprocessor system in accordance with the present invention, the second device driver software provided in the processing section on the receiving side may make the second protocol software process the transmitted data by designating to the second protocol software a pointer for an area in the second memory device or the third memory device to which the transmitted data has been written, instead of executing readout from the shared memory of the transmitted data and making the second protocol software process the transmitted data read out.

In the multiprocessor system in accordance with the present invention, transmission data may be transmitted from one processing section on the transmitting side to a plurality of processing sections on the receiving side at the time of data communication. In such a case, the multiprocessor system may include a notice signal distribution device which, when receiving the notice signal from the processing section on the transmitting side, distributes the notice signal to the plurality of processing sections on the receiving side.

According to the present invention, exclusive control of the shared memory is performed at the time of data communication between the processing sections by means of only the operation to output a notice signal from the processing section on the transmitting side to the processing section on the receiving side and the operation to detect input of the notice signal by the processing section on the receiving side, and data assurance is made by means of the protocol software. Therefore, redundancy relating to data assurance at the time of data communication between the processing sections can be reduced in comparison with the conventional multiprocessor system.

Also, the need for the operations performed in the conventional multiprocessor system: the operation to output a reception completion interrupt signal from the receiving side to the transmitting side and the operation to detect the reception completion interrupt input from the transmitting side can be eliminated. Therefore the number of notice lines can be reduced to contribute to a reduction in the circuit area of the multiprocessor system as well as to reduce the power consumption corresponding to these operations.

### BRIEF DESCRIPTION OF THE DRAWINGS

FIG. 1 is a block diagram of a multiprocessor system in Embodiment 1 of the present invention;

FIG. 2 is a diagram showing the flow of the operation of virtual network device drivers on the transmitting and receiving sides in the multiprocessor system in Embodiment 1;

FIG. 3 is a diagram showing a sequence of operations performed by the virtual network device drivers on the transmitting and receiving sides in the multiprocessor system in Embodiment 1;

FIG. 4 is a diagram for explaining the operation of the multiprocessor system in Embodiment 1;

FIG. 5 is a diagram for explaining the operation of the multiprocessor system in Embodiment 1;

FIG. 6 is a diagram for explaining the operation of the multiprocessor system in Embodiment 1;

FIG. 7 is a block diagram of a multiprocessor system in Embodiment 2 of the present invention;

FIG. 8 is a diagram showing the flow of the operation of virtual network device drivers on the transmitting and receiving sides in the multiprocessor system in Embodiment 2;

FIG. 9 is a diagram showing a sequence of operations performed by the virtual network device drivers on the transmitting and receiving sides in the multiprocessor system in Embodiment 2;

FIG. 10 is a block diagram of a multiprocessor system in Embodiment 3 of the present invention;

FIG. 11 is a diagram showing the flow of the operation of virtual network device drivers on the transmitting and receiving sides in the multiprocessor system in Embodiment 3;

FIG. 12 is a diagram showing a sequence of operations performed by the virtual network device drivers on the transmitting and receiving sides in the multiprocessor system in Embodiment 3;

FIG. 13 is a diagram for explaining the operation of the multiprocessor system in Embodiment 3;

FIG. 14 is a diagram for explaining the operation of the multiprocessor system in Embodiment 3;

FIG. 15 is a diagram for explaining the operation of the multiprocessor system in Embodiment 3;

FIG. 16 is a block diagram of a multiprocessor system in Embodiment 4 of the present invention;

FIG. 17 is a diagram showing the flow of the operation of virtual network device drivers on the transmitting and receiving sides in the multiprocessor system in Embodiment 4;

FIG. 18 is a diagram showing a sequence of operations performed by the virtual network device drivers on the transmitting and receiving sides in the multiprocessor system in Embodiment 4;

FIG. 19 is a block diagram of a conventional multiprocessor system;

FIG. 20 is a diagram showing the flow of the operation of virtual network device drivers on the transmitting and receiving sides in the conventional multiprocessor system;

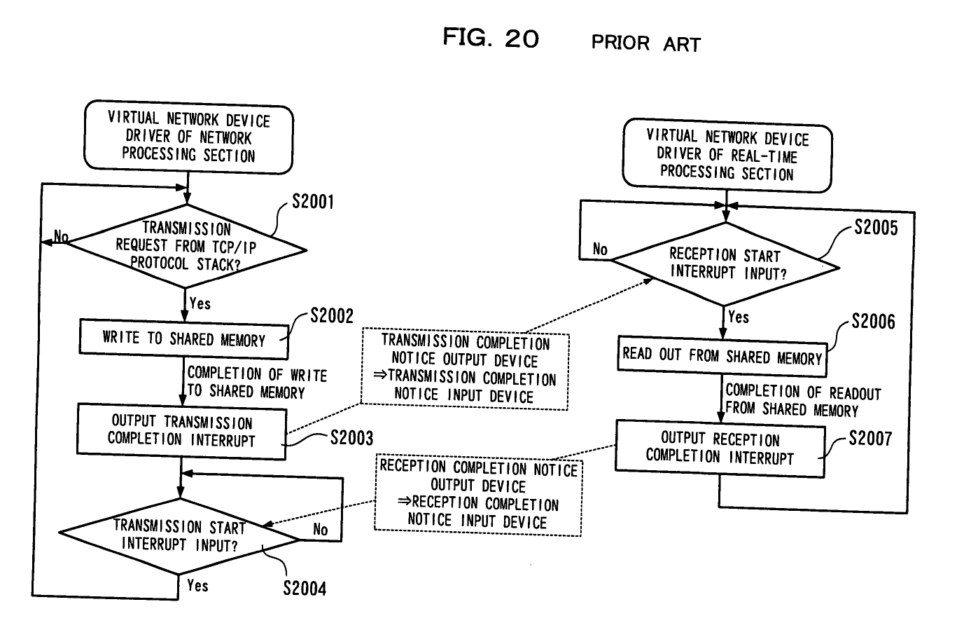

FIG. 21 is a diagram showing a sequence of operations performed by the virtual network device drivers on the transmitting and receiving sides in the conventional multiprocessor system;

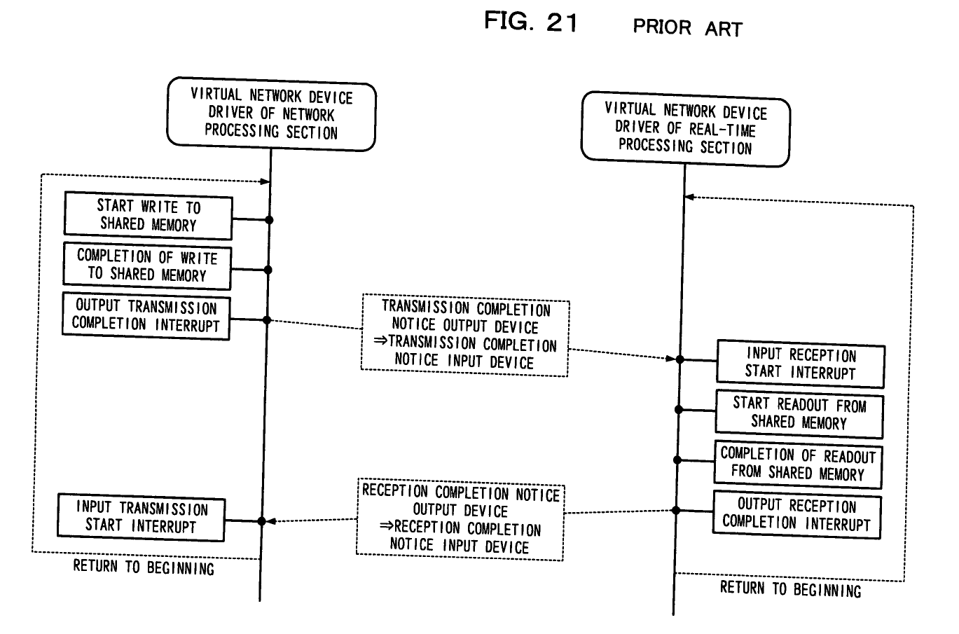

FIG. 22 is a diagram for explaining the operation-of the conventional multiprocessor system;

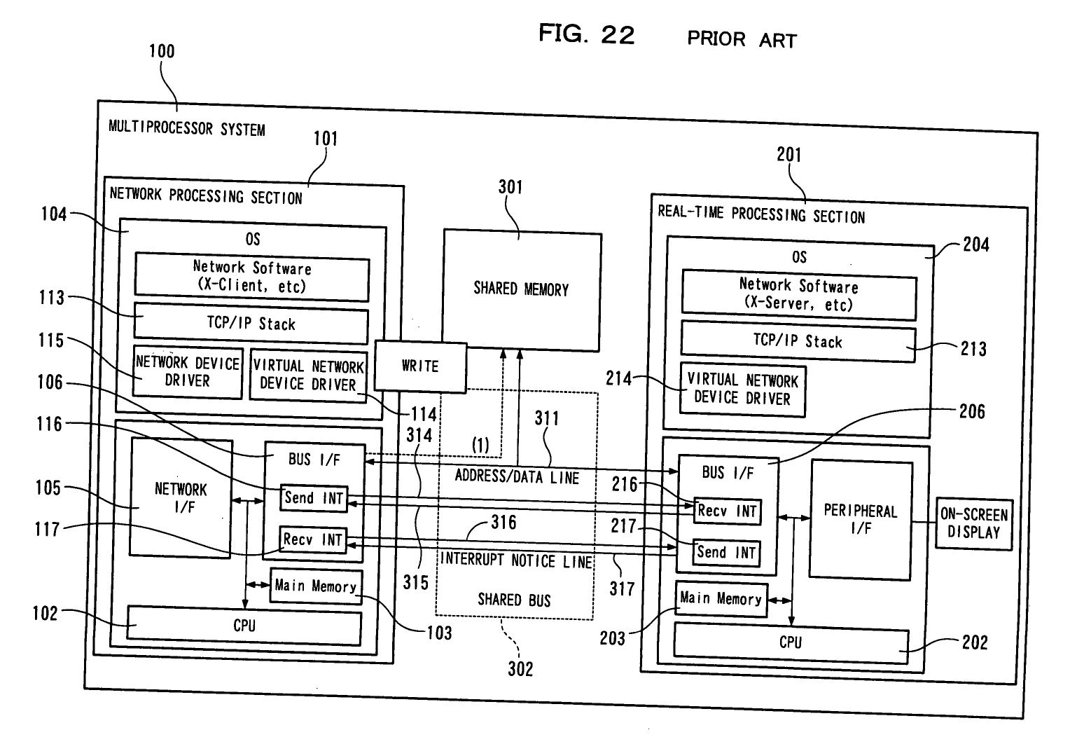

FIG. 23 is a diagram for explaining the operation of the conventional multiprocessor system;

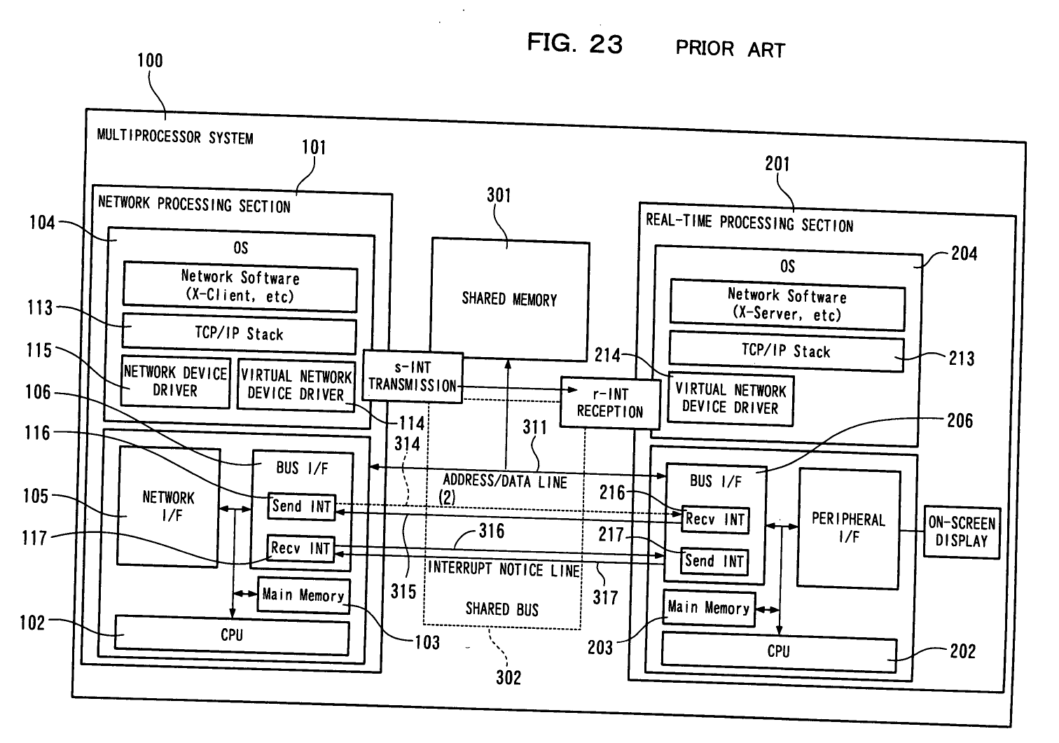

FIG. 24 is a diagram for explaining the operation of the conventional multiprocessor system;

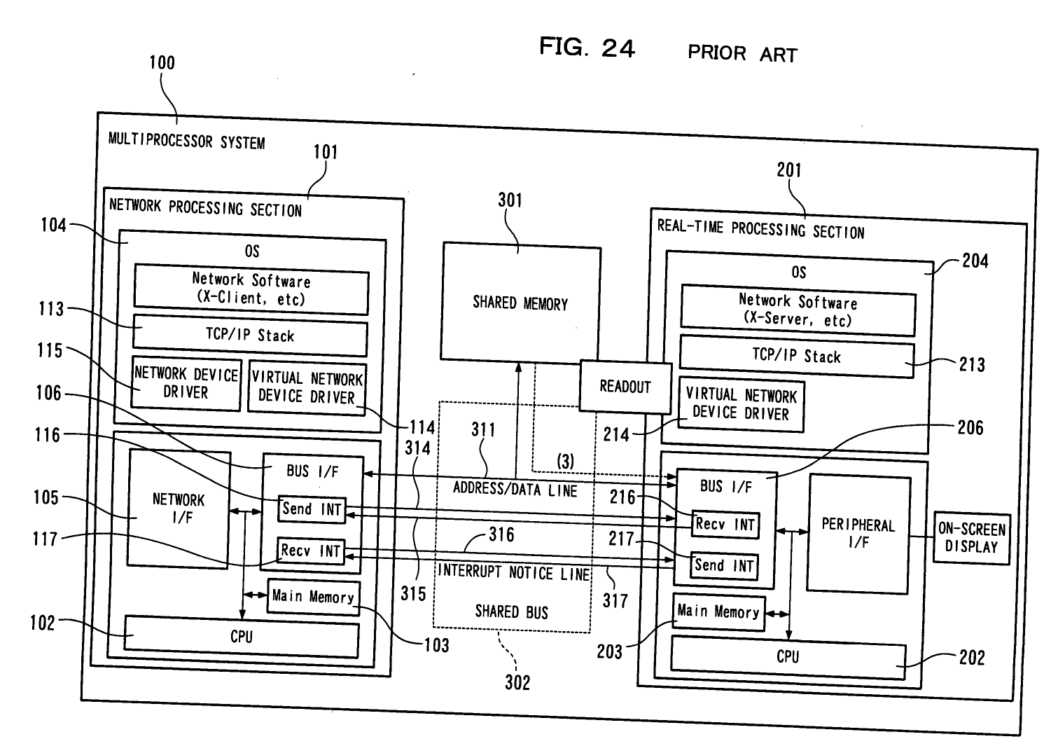

FIG. 25 is a diagram for explaining the operation of the conventional multiprocessor system;

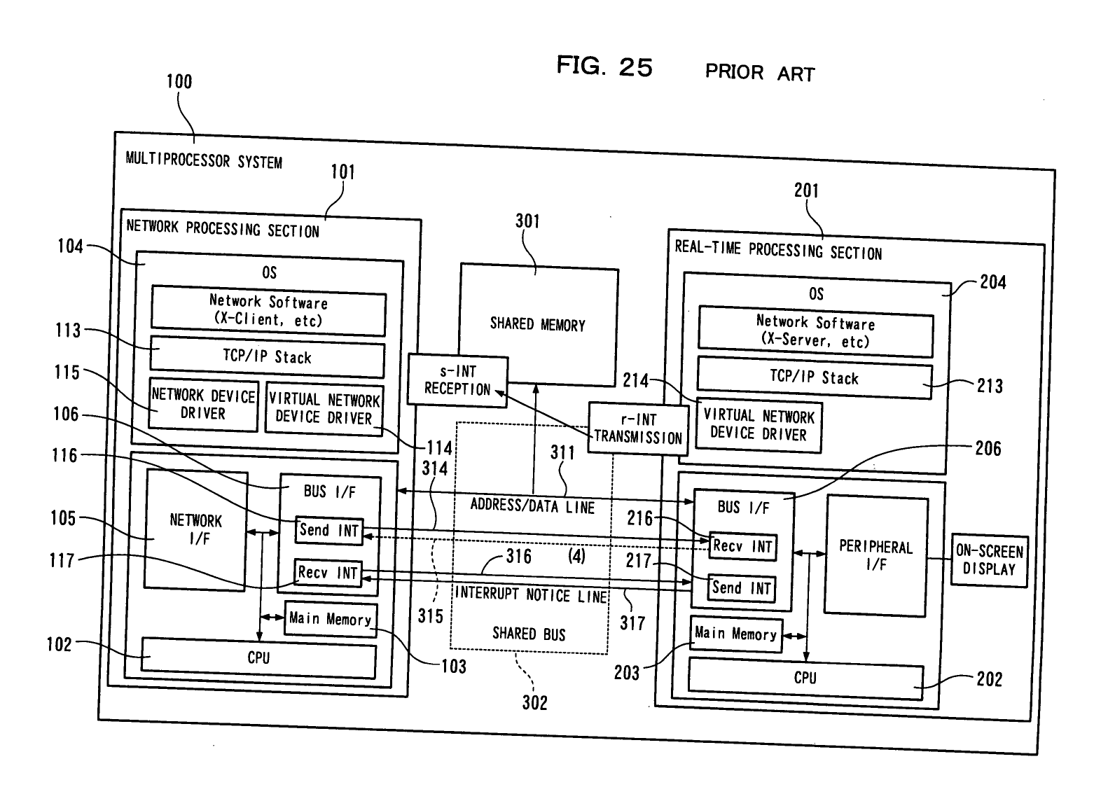

FIG. 26 is a block diagram of another conventional multiprocessor system; and

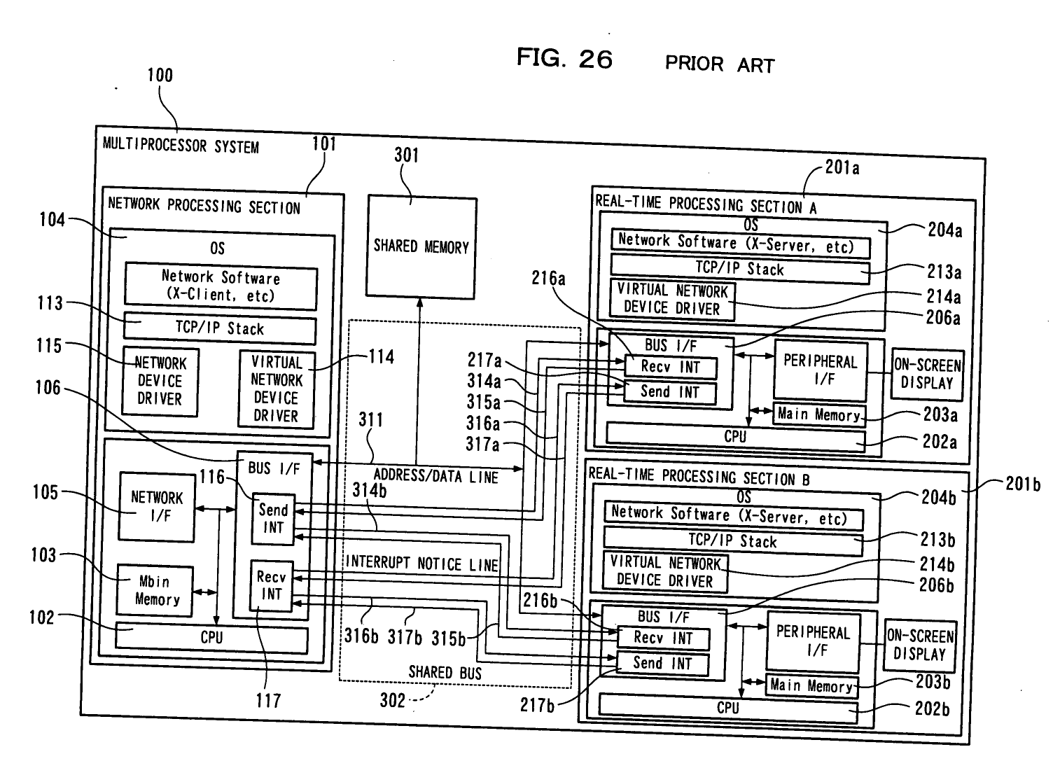

FIG. 27 is a diagram showing the flow of the operation of virtual network device drivers on the transmitting and receiving sides in the another conventional multiprocessor system.

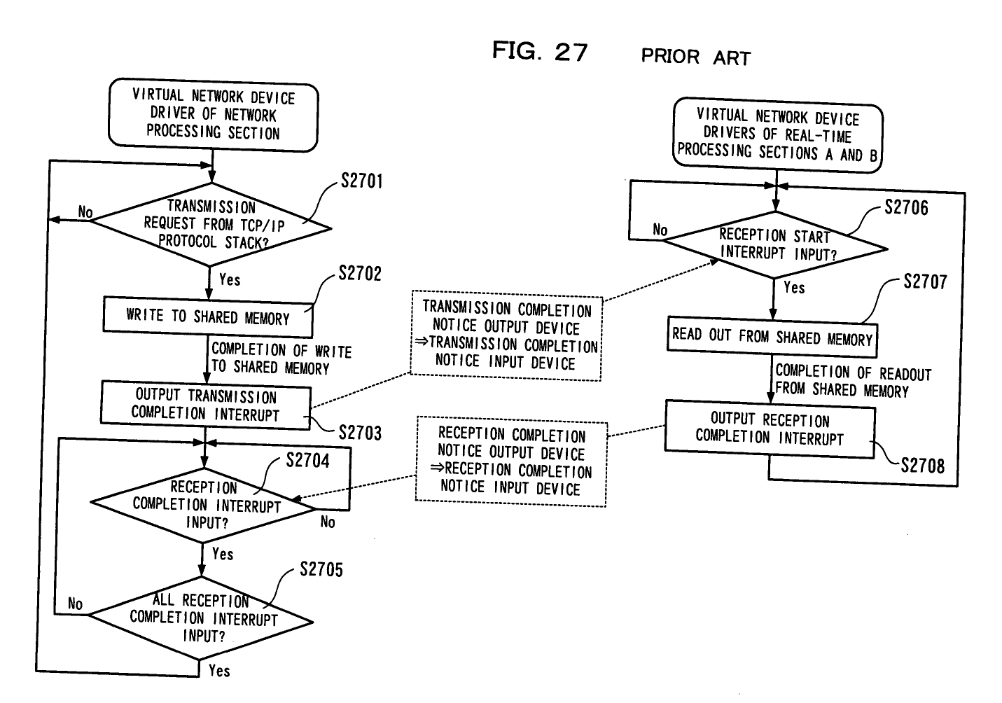

### DESCRIPTION OF THE EMBODIMENTS

### Embodiment 1

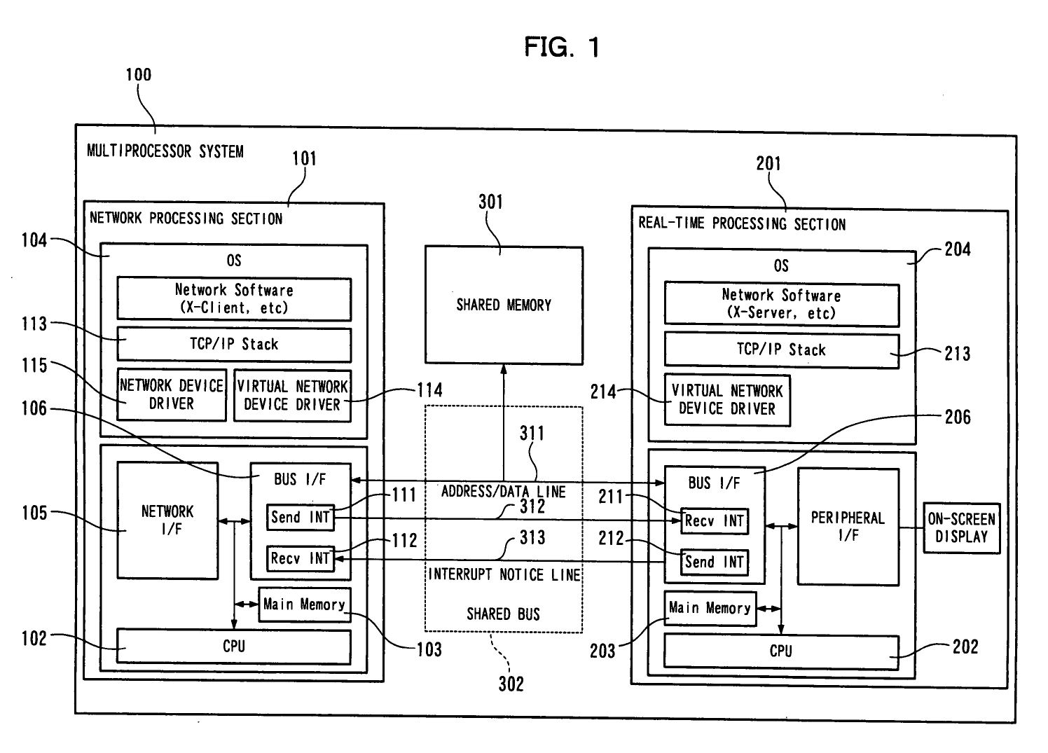

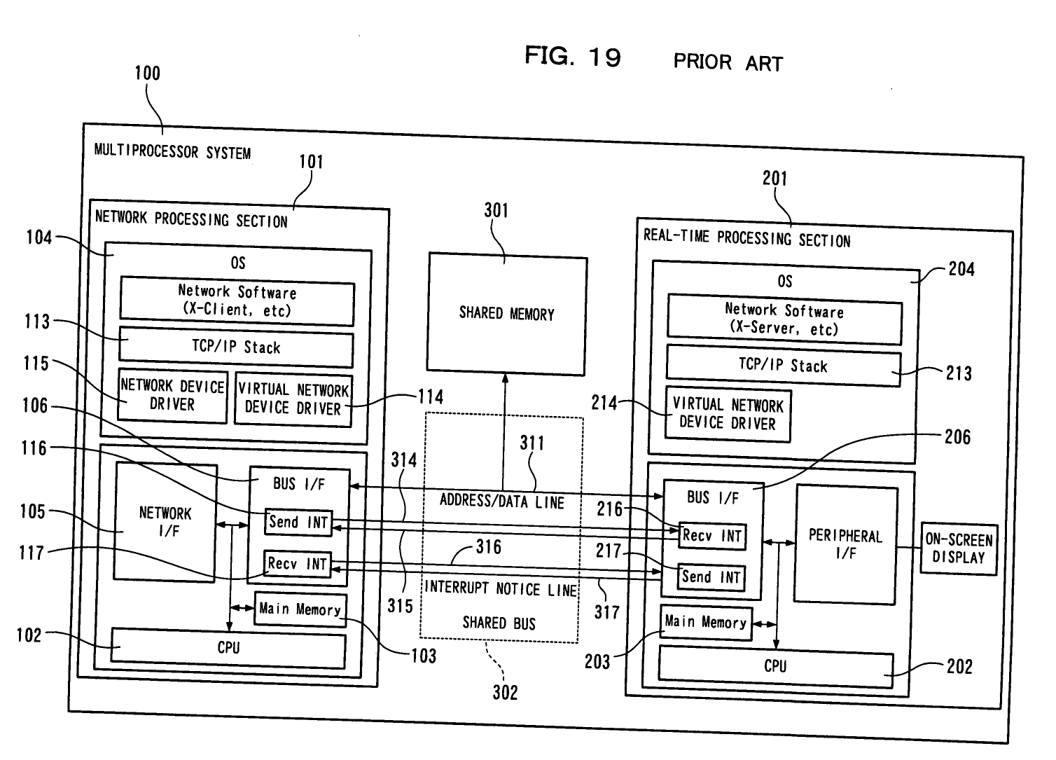

FIG. 1 is a block diagram of a multiprocessor system in Embodiment 1 of the present invention. Components corresponding to those described above with reference to FIG. 19 are indicated by the same reference numerals, and the description for them will not be repeated.

The multiprocessor system 100 in this embodiment is provided with a network processing section 101, a real-time processing section 201, a shared bus 302 connected between the network processing section 101 and the real-time processing section 201, and a shared memory 301 accessed from each processing section via the shared bus 302, as is that multiprocessor system shown in FIG. 19. However, the number of interrupt notice lines in the multiprocessor system 100 in this embodiment is half of that in the multiprocessor system shown in FIG. 19.

Referring to FIG. 1, the shared bus 302 has interrupt lines 312 and 313 through which interrupts are notified between the network processing section 101 and the real-time processing section 201.

The bus interface 106 of the network processing section 101 has a transmission completion notice output device 111. The bus interface 206 of the real-time processing section 201 has a transmission completion notice output device 212.

The transmission completion notice output device 111 outputs an interrupt signal to the interrupt notice line 312. The transmission completion notice output device 212 outputs an interrupt signal to the interrupt notice line 313.

The bus interface 106 of the network processing section 101 also has a reception start notice input device 112. The bus interface 206 of the real-time processing section 201 has a reception start notice input device 211.

The reception start notice input device 112 produces an interrupt in the CPU 102 by inputting a reception start interrupt signal from the interrupt notice line 313. The reception start notice input device 211 produces an interrupt in the CPU 202 by inputting a reception start interrupt signal from the interrupt notice line 312.

The virtual network device driver 114 of the network processing section 101 controls the bus interface 106 under the TCP/IP protocol stack 113 to control delivery of data to or from the TCP/IP protocol stack 113, data access to the shared memory 301 and interrupt signal input/output, as does that in the conventional multiprocessor system.

The virtual network device driver 214 of the real-time processing section 201 also controls the bus interface 206 under the TCP/IP protocol stack 213 to control delivery of data to or from the TCP/IP protocol stack 213, data access to the shared memory 301 and interrupt signal input/output, as does that in the conventional multiprocessor system.

The operation to output a reception completion interrupt signal from the receiving side to the transmitting side and the operation to detect the reception completion interrupt input from the transmitting side are not performed by the virtual network device drivers 114 and 214 at the time of data communication, while these operations are performed in the conventional multiprocessor system.

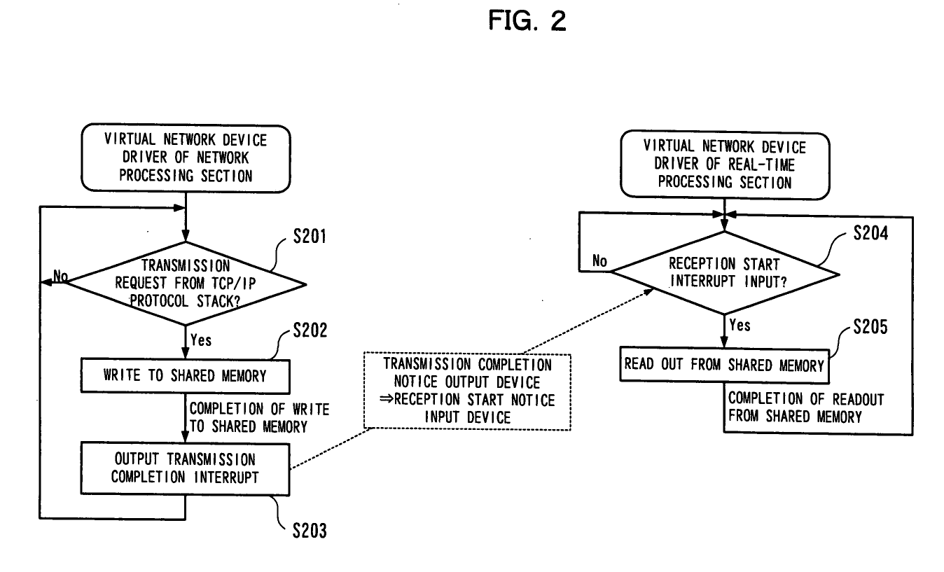

An example of the operation of this multiprocessor system 100 will be described with reference to FIGS. 2 to 6 by assuming that the network processing section 101 is on the data transmitting side while the real-time processing section 201 is on the data receiving side. However, data transmission from the real-time processing section 201 to the network processing section 101 can also be performed in the same manner.

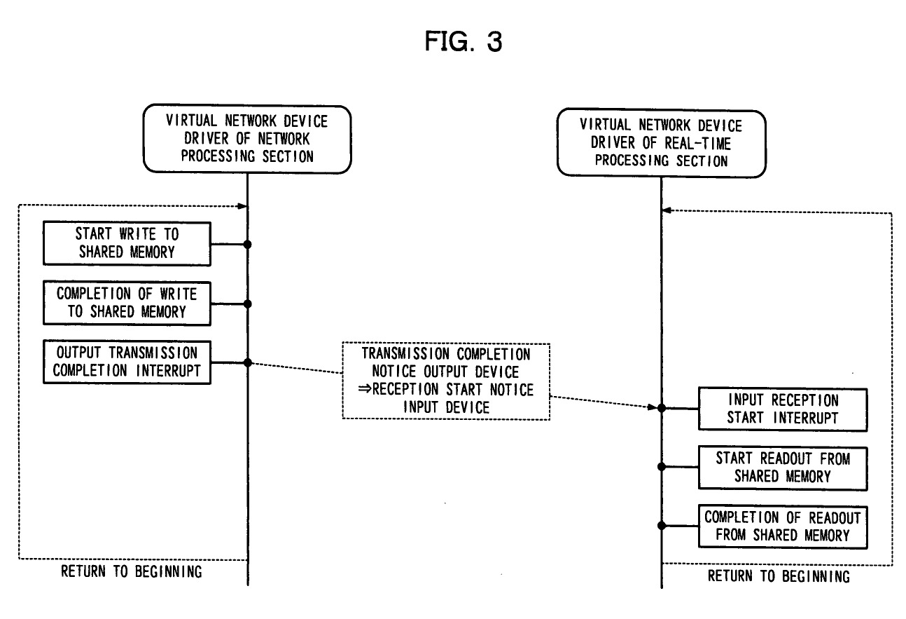

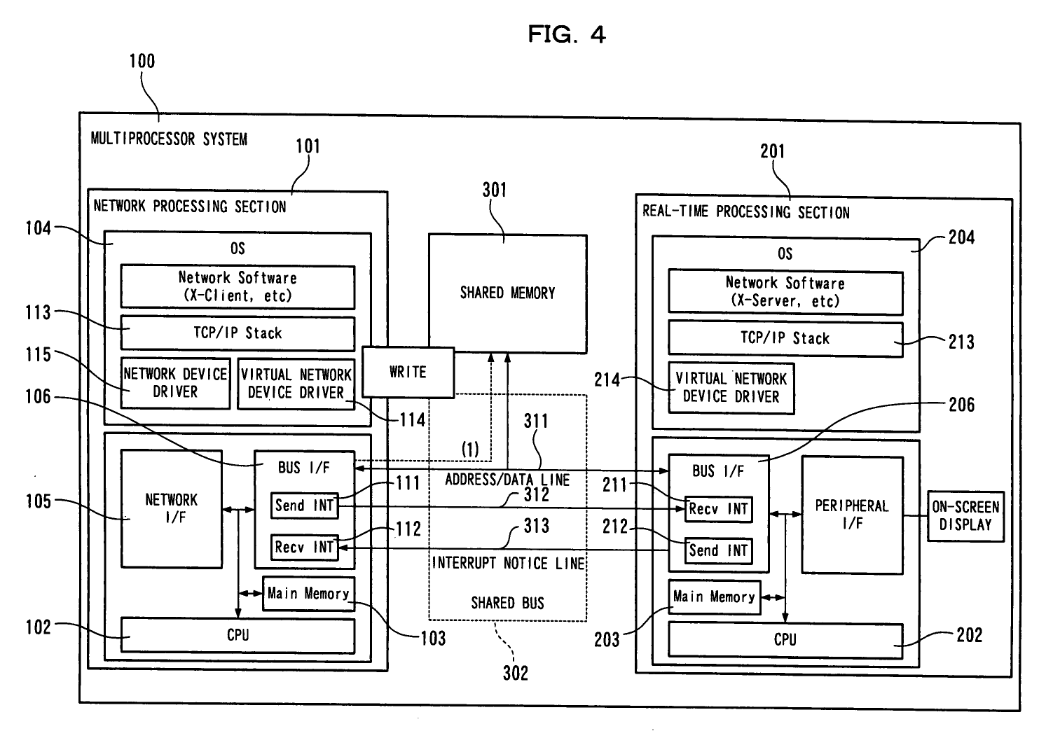

FIG. 2 shows the flow of the operation of the virtual network device driver 114 of the network processing section 101 on the transmitting side and the virtual network device driver 214 of the real-time processing section 201 on the receiving side. FIG. 3 shows a sequence of operations performed by the virtual network device driver 114 of the network processing section 101 on the transmitting side and the virtual network device driver 214 of the real-time processing section 201 on the receiving side. FIGS. 4 to 6 are diagrams for explaining the operation of the multiprocessor system 100.

In step S201, the virtual network device driver 114 of the network processing section 101 on the transmitting side receives a transmission request from the TCP/IP protocol stack 113. In step S202, upon receiving the request, the virtual network device driver 114 writes transmission data, which is received from the TCP/IP protocol stack 113, to the shared memory 301 via the bus interface 106 and the shared bus 302 (see (1) of FIG. 4).

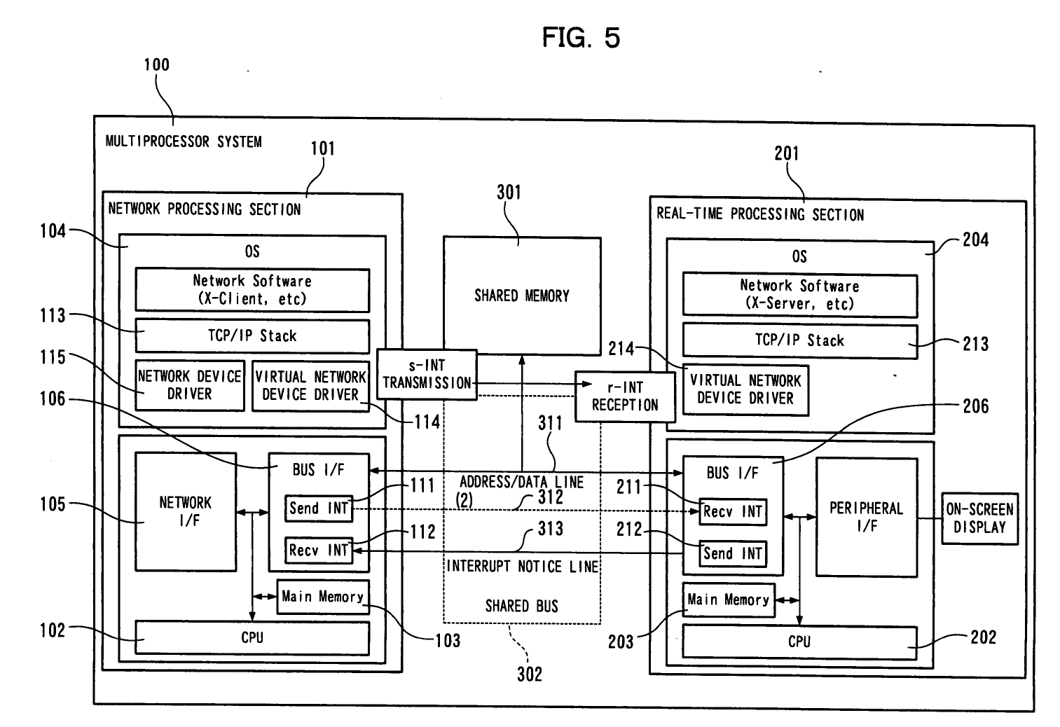

After the completion of writing, the virtual network device driver 114 transmits, in step S203, a transmission completion interrupt signal (a notice signal for notifying write to the shared memory of transmission data) to the interrupt notice line 312 by controlling the transmission completion notice output device (notice signal output device) 111 (S-INT transmission). The reception start notice input device (notice signal input device) 211 of the real-time processing section 201 on the receiving side receives the transmission completion interrupt signal transmitted through the interrupt notice line 312 (r-INT reception) and then produces an interrupt in the CPU 202 by inputting a reception start interrupt signal to the CPU 202 to start the virtual network device driver 214 (see (2) of FIG. 5).

Thus, in this embodiment, the transmission completion notice output device 111 operates as a notice signal output device to output a transmission completion interrupt signal as a notice signal for notifying write to the shared memory 301 of transmission data. Also, the reception start notice input device 211 operates as a notice signal input device to input the transmission completion interrupt signal as a notice signal from the network processing section 101 on the transmitting side. Also, the transmission completion interrupt signal as a notice signal from the network processing section 101 on the transmitting side to the real-time processing section 201 on the receiving side is transmitted through the interrupt notice line 312 at the time of data communication.

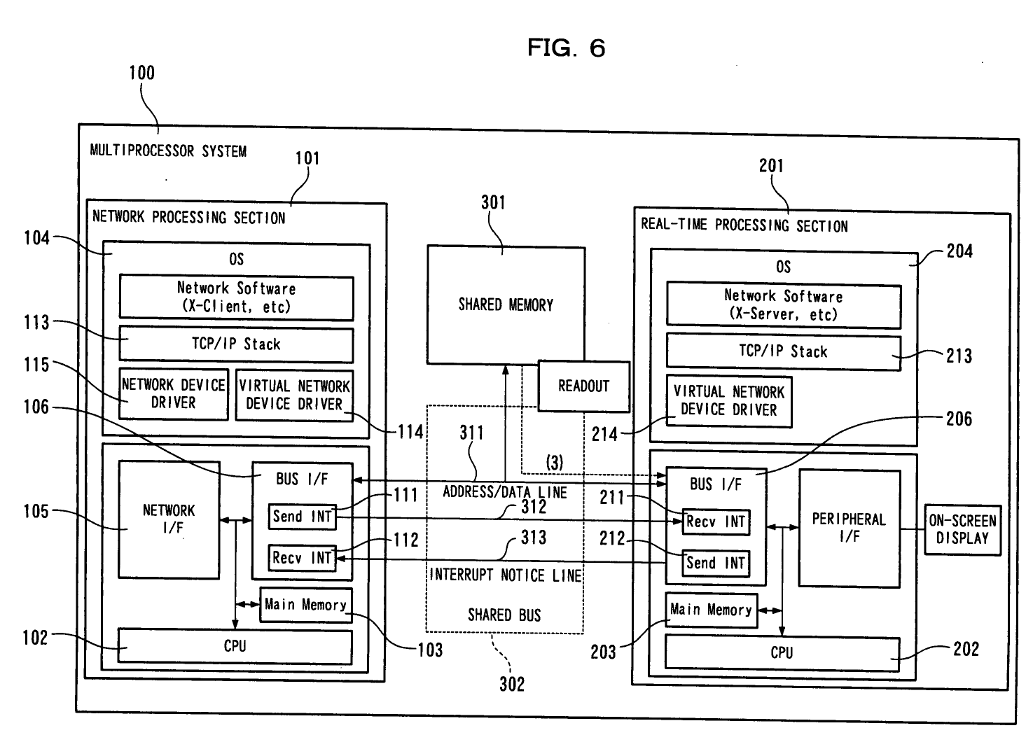

Upon reception of the reception start interrupt signal in step S204, the virtual network device driver 214 reads out, in step 205, the data written to the shared memory 301, via the shared bus 302 and the bus interface 206, and makes the TCP/IP protocol stack 213 process the transmitted data read out (see (3) of FIG. 6).

On the other hand, after outputting the transmission completion interrupt signal to the interrupt notice line 312, the virtual network device driver 114 of the network processing section 101 on the transmitting side enters a state of awaiting a transmission request from the TCP/IP protocol stack 113.

Therefore, if the operation performed by the virtual network device driver 214 of the real-time processing section 201 on the receiving side to read data from the shared memory 301 is delayed, there is a possibility that the transmission data in the shared memory 301 will be overwritten with the next data to transmitted by the virtual network device driver 114 of the network processing section 101 on the transmitting side.

However, the TCP protocol in the TCP/IP protocol stack, which is a piece of software for executing data communication, has the function of checking the check sum for detecting a change in data packets and the sequence number for detecting data loss and by requesting resending when detecting overwrite of part or the whole of the data to achieve data assurance. Therefore this multiprocessor system 100 can finally communicate correct data. That is, even if the data on the shared memory 301 is overwritten with the next data to transmitted by the virtual network device driver 114 of the network processing section 101 on the transmitting side, the TCP/IP protocol stack 213 in the real-time processing section 201 on the receiving side requests resending. Therefore this multiprocessor system 100 can communicate correct data.

Thus, in this embodiment, the TCP/IP protocol stack 113 in the network processing section 101 on the transmitting side functions as first protocol software capable of execution of data communication between the processing sections and data assurance, and the TCP/IP protocol stack 213 in the real-time processing section 201 on the receiving side functions as second protocol software capable of execution of data communication between the processing sections and data assurance,

Also, the virtual network device driver 114 of the network processing section 101 on the transmitting side functions as first device driver software for executing write to the shared memory 301 of transmission data received from the TCP/IP protocol stack 113 and output of the transmission completion interrupt signal (notice signal) by the transmission completion notice output device (notice signal output device) 111.

Also, the virtual network device driver 214 of the real-time processing section 201 on the receiving side functions as second device driver software for executing readout of the transmission data from the shared memory 301 and making the TCP/IP protocol stack 213 process the transmitted data read out after input of the transmission completion interrupt signal (notice signal) by the reception start notice input device (notice signal input device) 211.

In Embodiment 1, as described above, data assurance is performed only by the TCP/IP protocol stack and, therefore, only one interrupt notice line (one-half of the interrupt notice lines in the conventional multiprocessor system) suffices for exclusive control of the shared memory, thus eliminating the need for the operation to output the reception completion interrupt signal from the receiving side to the transmitting side and the operation to detect the reception completion interrupt input from the transmitting side, which are performed in the conventional multiprocessor system.

In Embodiment 1, the virtual network device driver 114 on the transmitting side executes output of the transmission completion interrupt signal by the transmission completion notice output device 111 (immediately) after the completion of write to the shared memory 301 of transmission data, and thereafter enters a state of awaiting a transmission request from the TCP/IP protocol stack 113. The arrangement may alternatively be such that the virtual network device driver 114 outputs the interrupt signal (immediately) before write to the shared memory 301 of transmission data and enters the transmission request awaiting state after the completion of write to the shared memory 301 of the transmission data, or such that the virtual network device driver 114 outputs the interrupt signal when a predetermined amount of written data is reached during write to the shared memory 301 of transmission data, and thereafter enters the transmission request awaiting state after the completion of write to the shared memory 301 of the transmission data.

In Embodiment 1, the TCP/IP protocol stack 113 (first protocol software) and the virtual network device driver 114 (first device driver software) are stored in the main memory 103 provided as a first memory device. However, the arrangement may alternatively be such that, for example, two memories in which the TCP/IP protocol stack 113 and the virtual network device driver 114 are stored separately from each other are provided as a first memory device.

Similarly, while in Embodiment 1 the TCP/IP protocol stack 213 (second protocol software) and the virtual network device driver 214 (second device driver software) are stored in the main memory 203 provided as a second memory device, the arrangement may alternatively be such that, for example, two memories in which the TCP/IP protocol stack 213 and the virtual network device driver 214 are stored separately from each other are provided as a second memory device.

### Embodiment 2

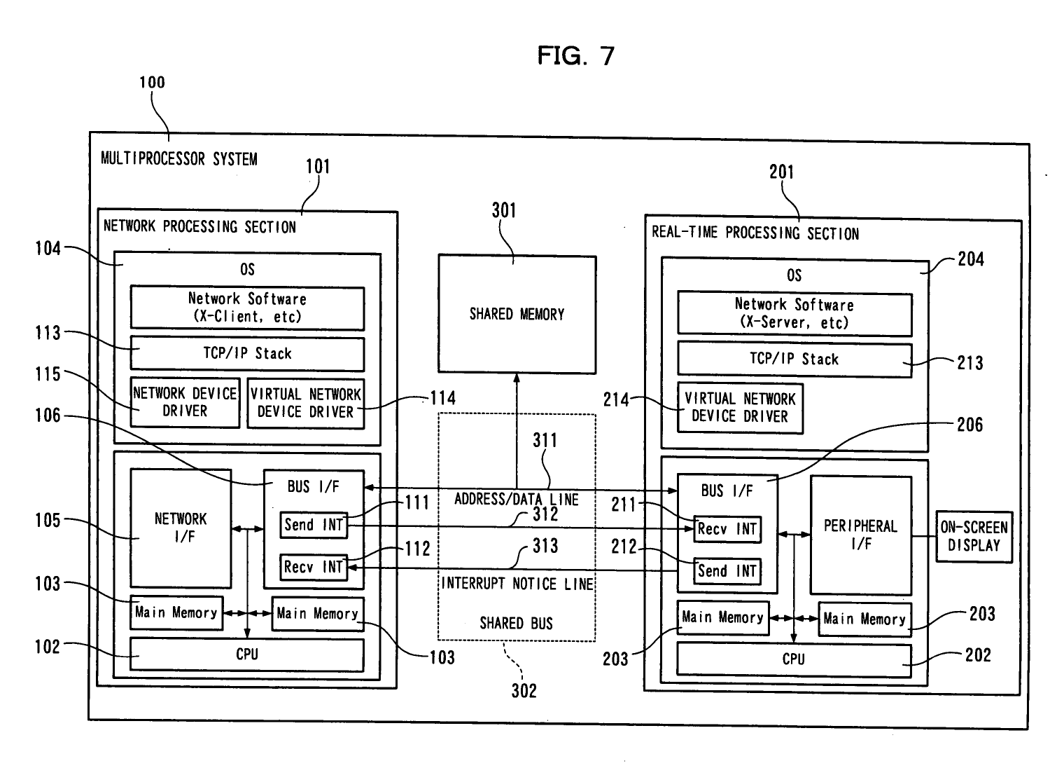

FIG. 7 is a block diagram of a multiprocessor system in Embodiment 2 of the present invention. Components corresponding to those described above with reference to FIG. 19 are indicated by the same reference numerals, and the description for them will not be repeated.

The multiprocessor system 100 in this embodiment differs from the multiprocessor system in Embodiment 1 in that the network processing section 101 and the real-time processing section 201 respectively have timers.

In the arrangement shown in FIG. 7, each of the timers 107 and 207 notifies timeout after a lapse of a predetermined time period (predicted value).

The virtual network device driver 114 of the network processing section 101 make the timer 107 start measuring time at the time of data transmission after the completion of write to the shared memory 301 of transmission data, enters a state of awaiting a transmission request from the TCP/IP protocol stack 113 after being notified of timeout from the timer 107, and executes write to the shared memory 301 of the next transmission data.

Also, the virtual network device driver 214 of the real-time processing section 201 make the timer 207 start measuring time at the time of data transmission after the completion of write to the shared memory 301 of transmission data, enters a state of awaiting a transmission request from the TCP/IP protocol stack 213 after being notified of timeout from the timer 207, and executes write to the shared memory 301 of the next transmission data.

As the predetermined time period, a time period required for readout of data from the shared memory 301 on the data receiving side is predicted and set.

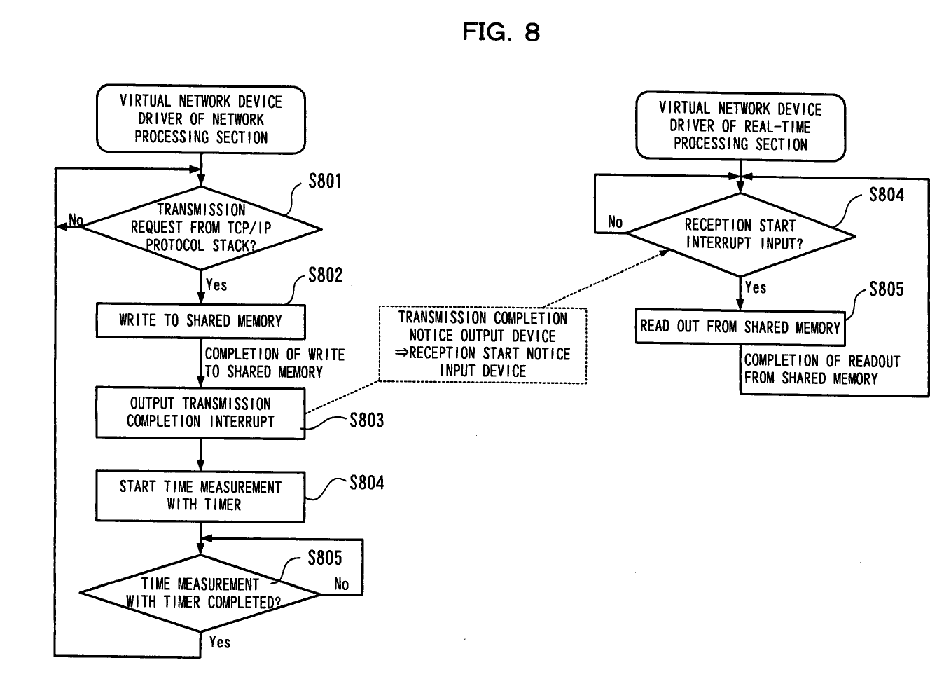

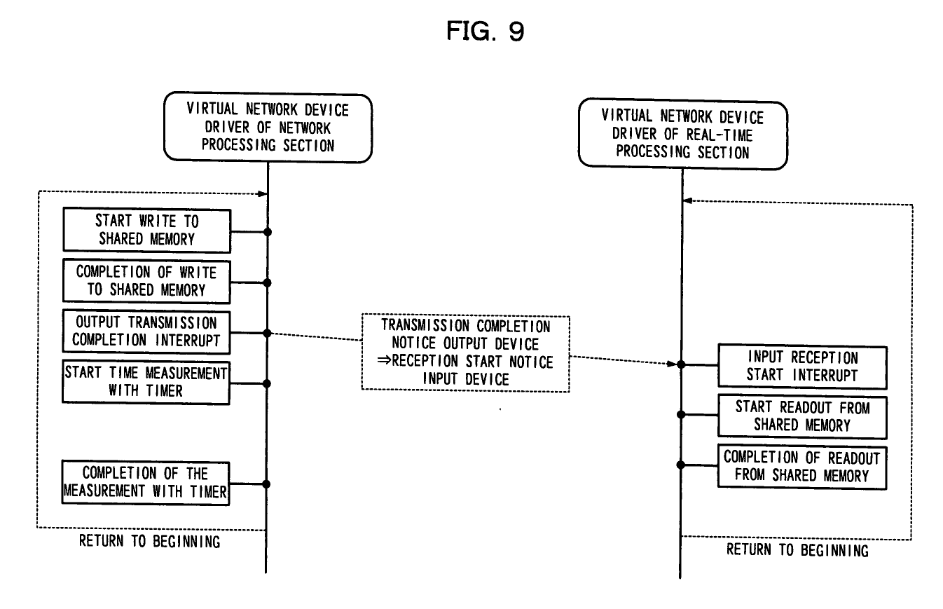

An example of the operation of this multiprocessor system 100 will be described with reference to FIGS. 8 and 9 by assuming that the network processing section 101 is on the data transmitting side while the real-time processing section 201 is on the data receiving side. However, data transmission from the real-time processing section 210 to the network processing section 101 can also be performed in the same manner. Also, in this embodiment, the timer 107 is started to measure time immediately after the completion of write of data to the shared memory 301 and output of the transmission completion interrupt signal from the transmission completion notice output device 111.

FIG. 8 shows the flow of the operation of the virtual network device driver 114 of the network processing section 101 on the transmitting side and the virtual network device driver 214 of the real-time processing section 201 on the receiving side. FIG. 9 shows a sequence of operations performed by the virtual network device driver 114 of the network processing section 101 on the transmitting side and the virtual network device driver 214 of the real-time processing section 201 on the receiving side.

In step S801, the virtual network device driver 114 of the network processing section 101 on the transmitting side receives a transmission request from the TCP/IP protocol stack 113. In step S802, upon receiving the request, the virtual network device driver 114 writes transmission data, which is received from the TCP/IP protocol stack 113, to the shared memory 301 via the bus interface 106 and the shared bus 302.

After the completion of writing, the virtual network device driver 114 transmits, in step S803, a transmission completion interrupt signal (a notice signal for notifying write to the shared memory of transmission data) to the interrupt notice line 312 by controlling the transmission completion notice output device (notice signal output device) 111.

The reception start notice input device (notice signal input device) 211 of the real-time processing section 201 on the receiving side receives the transmission completion interrupt signal transmitted through the interrupt notice line 312 and then produces an interrupt in the CPU 202 by inputting a reception start interrupt signal to the CPU 202 to start the virtual network device driver 214.

Upon reception of the reception start interrupt signal in step S806, the virtual network device driver 214 reads out, in step 807, the data written to the shared memory 301, via the shared bus 302 and the bus interface 206, and makes the TCP/IP protocol stack 213 process the transmitted data read out.

On the other hand, after outputting the transmission completion interrupt signal to the interrupt notice line 312, the virtual network device driver 114 of the network processing section 101 on the transmitting side immediately starts the timer 107 in step S804 to start measuring time.

In the timer 107, a predicted value of the time period required for the real-time processing section 201 on the receiving side to read out data from the shared memory 301 is set, as mentioned above. After a lapse of the time period equal to the predicted value, the timer 107 notifies the virtual network device driver 114 of timeout. Upon receiving the timeout notice from the timer 107 in step S805, the virtual network device driver 114 determines the completion of time measurement and enters a state of awaiting a transmission request from the TCP/IP protocol stack 113.

According to Embodiment 2, the virtual network device driver 114 on the transmitting side does not enter a state of awaiting a transmission request from the TCP/IP protocol stack 113 before it is notified of timeout from the timer 107. The possibility that the transmission data written to the shared memory 301 will be overwritten with the next transmission data by the virtual network device driver 114 on the transmitting side is therefore reduced, thus reducing processing for resending by the TCP protocol.

While Embodiment 2 has been described with respect to a case where the timer 107 is started to measure time immediately after the completion of write of data to the shared memory 301 and output of the transmission completion interrupt signal from the transmission completion notice output device 111, the time 107 may be started after a lapse of a certain time period from the completion of write of data to the shared memory 301, which time period is freely selected. If the interrupt signal is output (immediately) before write of data to the shared memory 301 or when a predetermined amount of written data is reached during write to the shared memory 301 of transmission data, the timer 107 may be started (immediately) after the completion of write to the shared memory of the date to be transmitted.

Also, one memory for storing the TCP/IP protocol stack 113 (first protocol software) and the virtual network device driver 114 (first device driver) or two memories for separately storing the TCP/IP protocol stack 113 and the virtual network device driver 114 may be provided as the first memory device, as in Embodiment 1. Also, one memory for storing the TCP/IP protocol stack 213 (second protocol software) and the virtual network device driver 214 (second device driver) or two memories for separately storing the TCP/IP protocol stack 213 and the virtual network device driver 214 may be provided as the second memory device.

### Embodiment 3

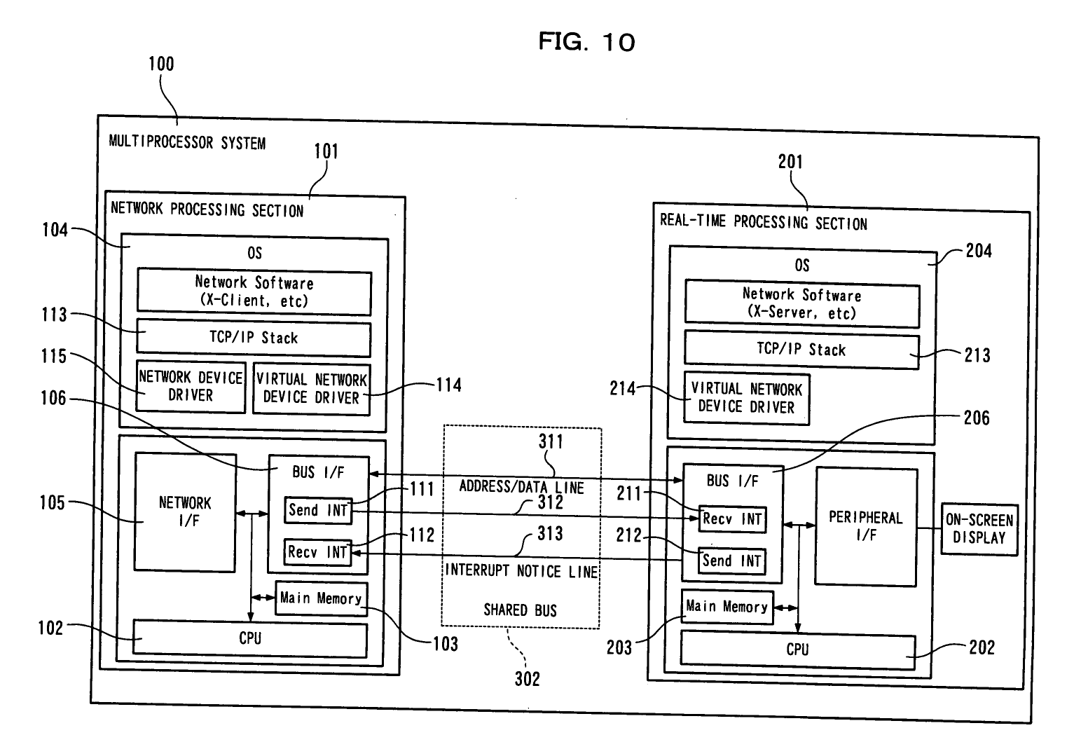

FIG. 10 is a block diagram of a multiprocessor system in Embodiment 3 of the present invention. Components corresponding to those described above with reference to FIGS. 1 and 19 are indicated by the same reference numerals, and the description for them will not be repeated.

The multiprocessor system 100 in this embodiment differs from the multiprocessor systems in Embodiments 1 and 2 in that the main memory provided in the processing section on the receiving side includes a memory area (shared memory) in which data transmitted at the time of data communication between the processing sections is temporarily stored.

That is, in this multiprocessor system 100, the main memory 103 provided in the network processing section 101 and the main memory 203 provided in the real-time processing section 201 are made sharable and data can be written directly from the transmitting side to the main memory on the receiving side.

In the arrangement shown in FIG. 10, the main memory 103 provided in the network processing section 101 and the main memory 203 provided in the real-time processing section 201 are sharable memories.

The virtual network device driver 114 of the network processing section 101 writes, to the main memory 203, via the bus interface 206 of the real-time processing section 201 on the receiving side, transmission data, by controlling the bus interface 106, when performing data transmission from the network processing section 101 to the real-time processing section 201. Similarly, the virtual network device driver 214 of the real-time processing section 201 writes, to the main memory 103, via the bus interface 106 of the network processing section 101 on the receiving side, transmission data, by controlling the bus interface 206, when performing data transmission from the real-time processing section 201 to the network processing section 101.

Also, the virtual network device driver in the processing section on the receiving side designates to the TCP/IP protocol stack a pointer for the area in the main memory to which the transmitted data has been written. The TCP/IP protocol stack processes the data in the area indicated by the pointer on the basis of the TCP/IP protocol.

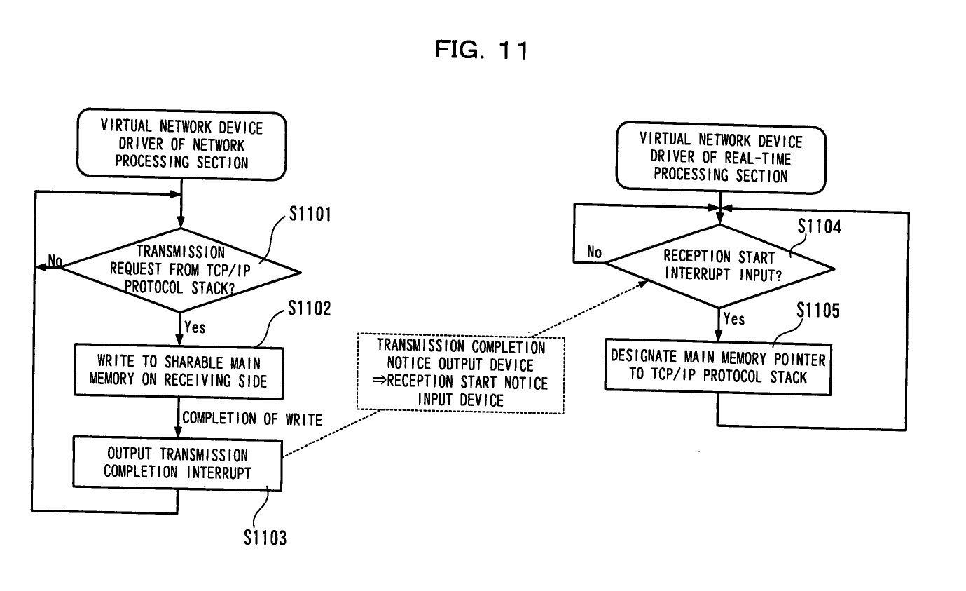

An example of the operation of this multiprocessor system 100 will be described with reference to FIGS. 11 to 15 by assuming that the network processing section 101 is on the data transmitting side while the real-time processing section 201 is on the data receiving side. However, data transmission from the real-time processing section 201 to the network processing section 101 can also be performed in the same manner.

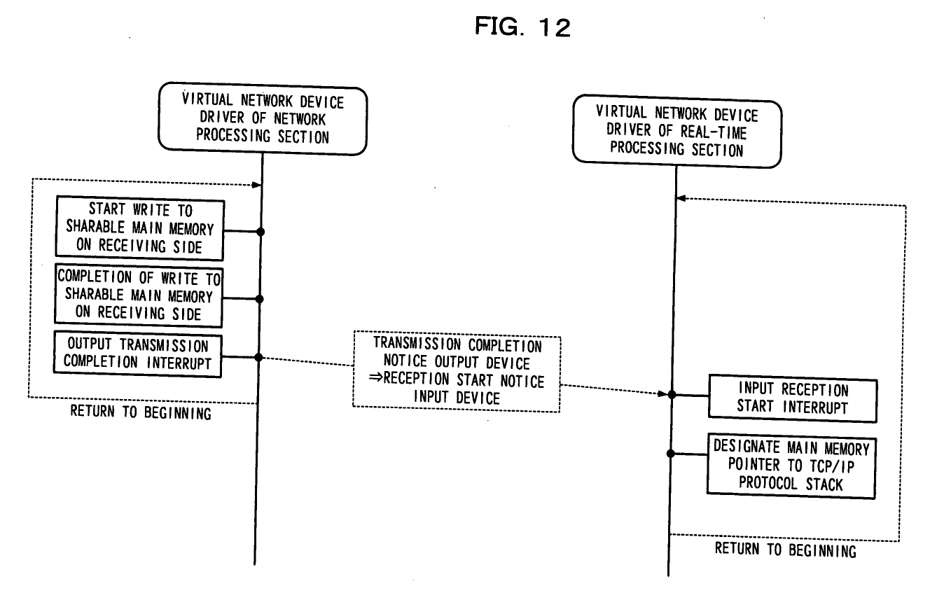

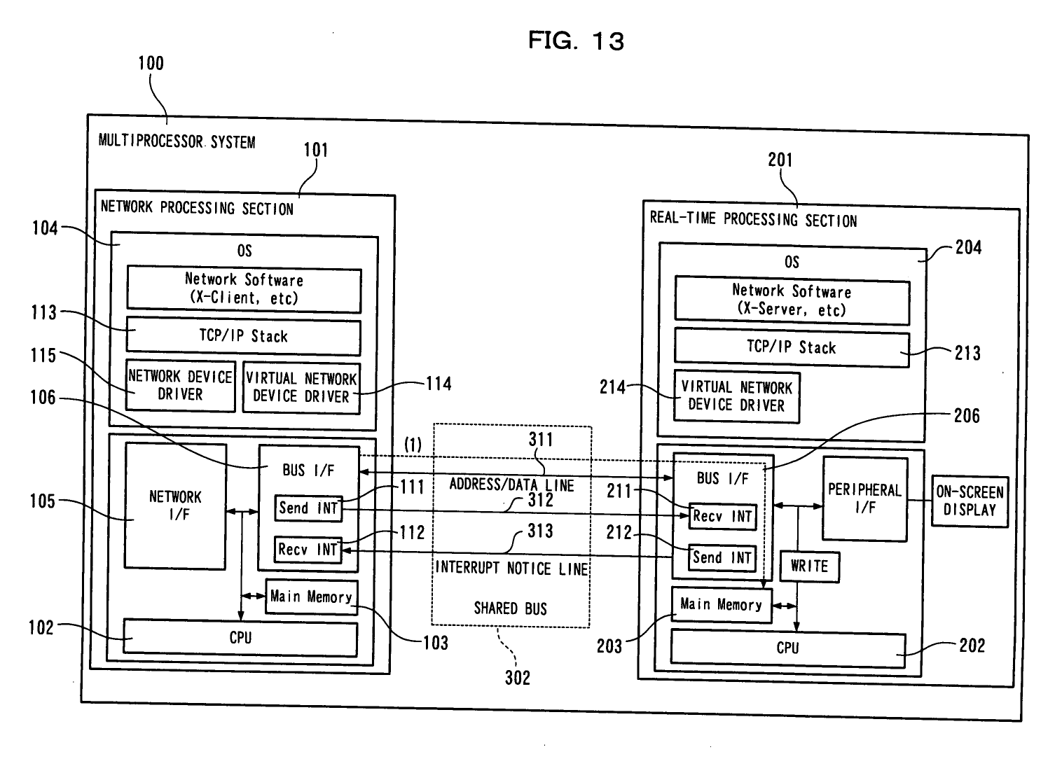

FIG. 11 shows the flow of the operation of the virtual network device driver 114 of the network processing section 101 on the transmitting side and the virtual network device driver 214 of the real-time processing section 201 on the receiving side. FIG. 12 shows a sequence of operations performed by the virtual network device driver 114 of the network processing section 101 on the transmitting side and the virtual network device driver 214 of the real-time processing section 201 on the receiving side. FIGS. 13 to 15 are diagrams for explaining the operation of the multiprocessor system 100. In step S1101, the virtual network device driver 114 of the network processing section 101 on the transmitting side receives a transmission request from the TCP/IP protocol stack 113. In step S1102, upon receiving the request, the virtual network device driver 114 writes transmission data, which is received from the TCP/IP protocol stack 113, to the main memory 203 via the bus interface 106, the shared bus 302 and the bus interface 206 of the real-time processing section 201 on the receiving side (see (1) of FIG. 13).

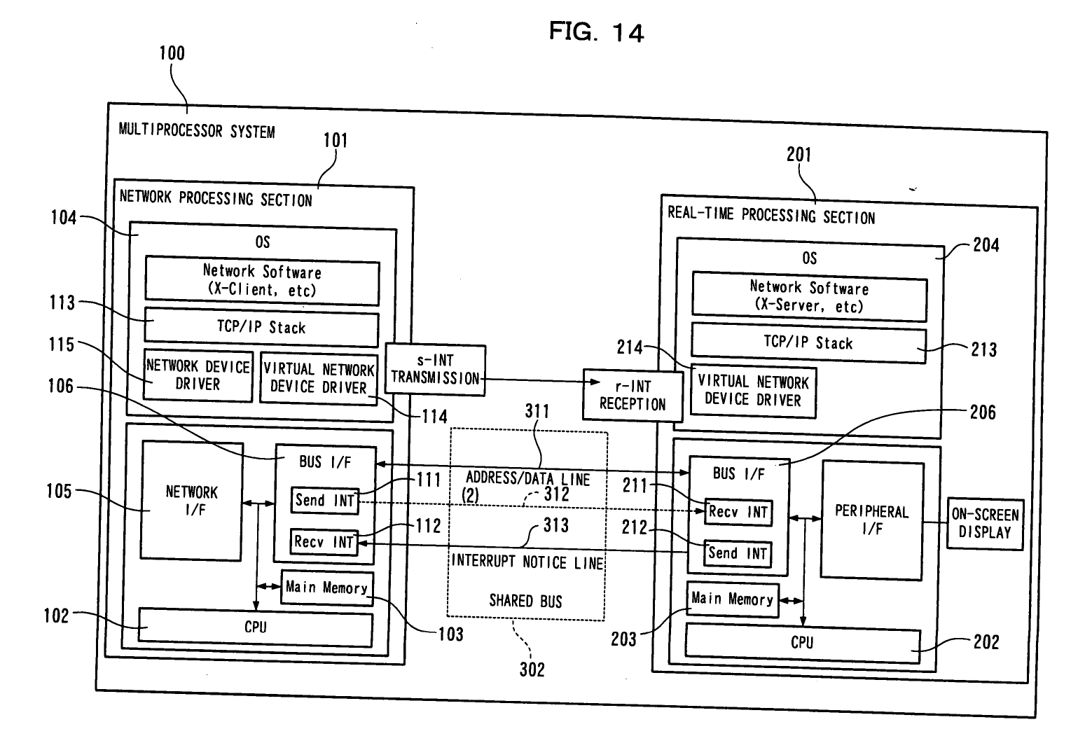

After the completion of writing, the virtual network device driver 114 transmits, in step S1103, a transmission completion interrupt signal (a notice signal for notifying write to the shared memory of transmission data) to the interrupt notice line 312 by controlling the transmission completion notice output device (notice signal output device) 111 (S-INT transmission). The reception start notice input device (notice signal input device) 211 of the real-time processing section 201 on the receiving side receives the transmission completion interrupt signal transmitted through the interrupt notice line 312 (r-INT reception) and then produces an interrupt in the CPU 202 by inputting a reception start interrupt signal to the CPU 202 to start the virtual network device driver 214 (see (2) of FIG. 14).

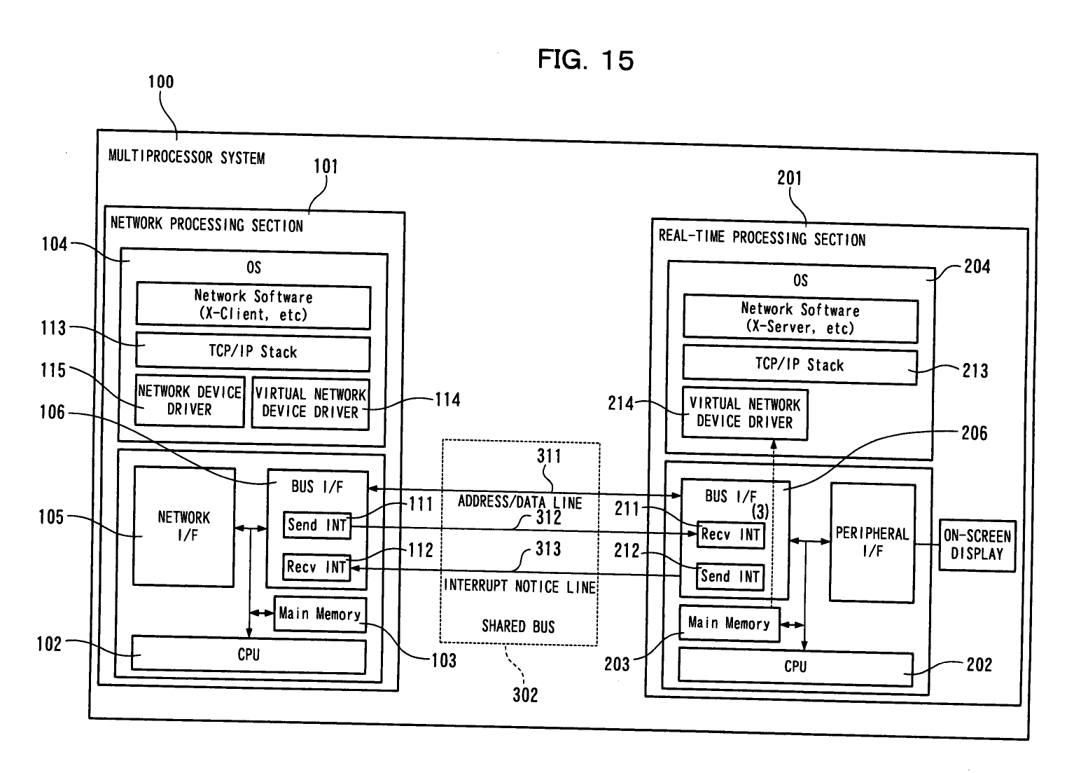

Upon reception of the reception start interrupt signal in step S1104, the virtual network device driver 214 makes the TCP/IP protocol stack 213 process the transmitted data in step 1105 by designating to the TCP/IP protocol stack 213 the pointer for the memory area in the main memory 203 to which the transmitted data has been written (see (3) of FIG. 15).

On the other hand, after outputting the transmission completion interrupt signal to the interrupt notice line 312, the virtual network device driver 114 of the network processing section 101 on the transmitting side enters a state of awaiting a transmission request from the TCP/IP protocol stack 113.

According to Embodiment 3, as described above, the need for the operation to read data from the shared memory to the receiving side (copying operation) is eliminated to reduce the load on the virtual network device driver. Further, since the copying time required for reception is reduced, the possibility that the transmitted data written to the main memory on the receiving side will be overwritten with the next transmission data by the processing section on the transmitting side is reduced, thus reducing processing for resending by the TCP protocol.

While in Embodiment 3 the main memories are made sharable, a shared memory (a third memory device) may be provided in the processing section on the receiving side separately from the main memory. Even in such a case, processing for resending by the TCP protocol can be reduced since the shared memory is provided at such a position that the speed of access to the shared memory from the processing section on the receiving side is higher than the speed of access to the shared memory from the processing section on the transmitting side.

The virtual network device driver 114 on the transmitting side may execute output of the transmission completion interrupt signal by the transmission completion notice output device 111 (immediately) after the completion of write to the main memory 203 (shared memory) of transmission data, and thereafter enter a state of awaiting a transmission request from the TCP/IP protocol stack 113, may output the interrupt signal (immediately) before write to the main memory 203 of transmission data, and enter the transmission request awaiting state after the completion of write to the main memory 203 of the transmission data, or may output the interrupt signal when a predetermined amount of written data is reached during write to the main memory 203 of transmission data and enter the transmission request awaiting state after the completion of write to the main memory 203 of the transmission data, as is that in Embodiment 1. Also, a timer may be provided in the same manner as in Embodiment 2.

Also, one memory for storing the TCP/IP protocol stack 113 (first protocol software) and the virtual network device driver 114 (first device driver) or two memories for separately storing the TCP/IP protocol stack 113 and the virtual network device driver 114 may be provided as the first memory device, as in Embodiment 1. Also, one memory for storing the TCP/IP protocol stack 213 (second protocol software) and the virtual network device driver 214 (second device driver) or two memories for separately storing the TCP/IP protocol stack 213 and the virtual network device driver 214 may be provided as the second memory device. In a case where two memories are provided, one of the two memories may include a shared memory or each of the two memories may include a shared memory.

### Embodiment 4

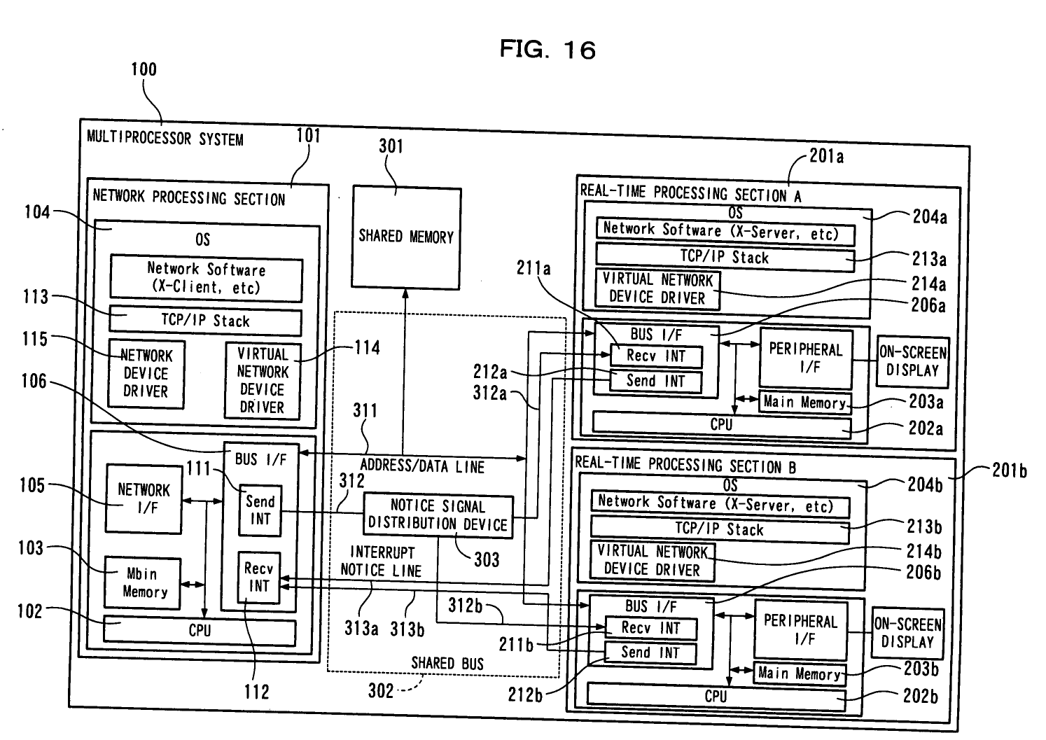

FIG. 16 is a block diagram of a multiprocessor system in Embodiment 4 of the present invention. Components corresponding to those described above with reference to FIGS. 1 and 19 are indicated by the same reference numerals, and the description for them will not be repeated.

The multiprocessor system 100 in this embodiment differs from the above-described multiprocessor system in Embodiment 1 in that a plurality of real-time processing sections are provided. Description will be made by way of example of a case where two real-time processing sections A201a and B201b are provided.

Referring to FIG. 16, when data is transmitted from the network processing section 101 to the real-time processing sections A201a and B201b (1:2 data transmission), a notice signal distribution device 303 receives a transmission completion interrupt signal from the network processing section 101 via the interrupt notice line 312 and distributes and outputs the transmission completion interrupt signal to interrupt notice lines 312a and 312b. The transmission completion interrupt signal is transmitted to the real-time processing sections A201a and B201b on the receiving side through the interrupt notice lines 312a and 312b.

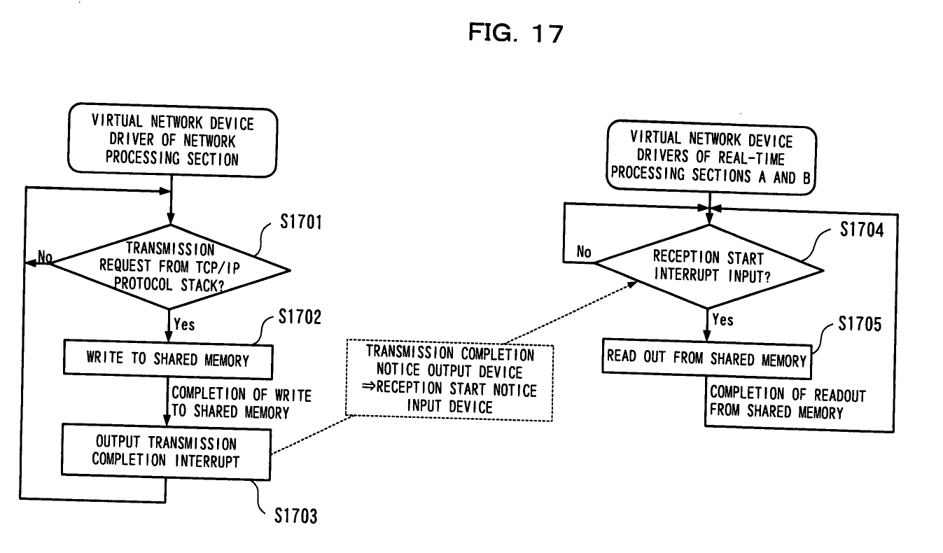

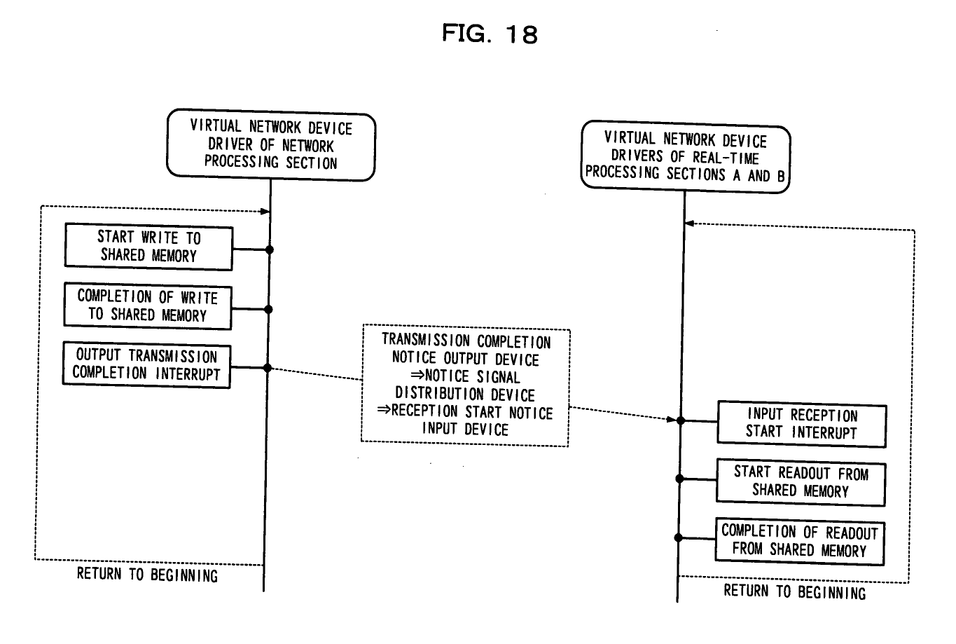

An example of the operation of this multiprocessor system 100 will be described with reference to FIGS. 17 and 18 by assuming that the network processing section 101 is on the data transmitting side while the real-time processing sections A201a and B201b are on the data receiving side. However, data transmission from the real-time processing section A201a or B201b to the network processing section 101 can also be performed in the same manner as in Embodiment 1.

FIG. 17 shows the flow of the operation of the virtual network device driver 114 of the network processing section 101 on the transmitting side and virtual network device drivers 214a and 214b of the real-time processing sections A201a and B201b on the receiving side. FIG. 18 shows a sequence of operations performed by the virtual network device driver 114 of the network processing section 101 on the transmitting side and the virtual network device drivers 214a and 214b of the real-time processing section A201a and B201b on the receiving side.

In step S1701, the virtual network device driver 114 of the network processing section 101 on the transmitting side receives a transmission request from the TCP/IP protocol stack 113. In step S1702, upon receiving the request, the virtual network device driver 114 writes transmission data, which is received from the TCP/IP protocol stack 113, to the shared memory 301 via the bus interface 106 and the shared bus 302.

After the completion of writing, the virtual network device driver 114 transmits, in step S1703, a transmission completion interrupt signal (a notice signal for notifying write to the shared memory of transmission data) to the interrupt notice line 312 by controlling the transmission completion notice output device (notice signal output device) 111.

When the notice signal distribution device 303 receives the transmission completion interrupt signal input thereto from the network processing section 101 on the transmitting side, it distributes and outputs the same signals as the transmission completion interrupt signal to the interrupt notice lines 312a and 312b.

Each of reception start notice input devices (notice signal input devices) 211a and 211b of the real-time processing sections A201a and B201b on the receiving side receives the transmission completion interrupt signal transmitted through the interrupt notice line 312a or 312b and then produces an interrupt in the CPU 202a or 202b by inputting a reception start interrupt signal to the CPU to start the virtual network device driver 214a or 214b.

Upon reception of the reception start interrupt signal in step S1704, each of the virtual network device drivers 214a and 214b reads out, in step 1705, the data written to the shared memory 301, via the shared bus 302 and a bus interface 206a or 206b, and makes the TCP/IP protocol stack 213a or 213b process the transmitted data read out.

On the other hand, after outputting the transmission completion interrupt signal to the interrupt notice line 312, the virtual network device driver 114 of the network processing section 101 on the transmitting side enters a state of awaiting a transmission request from the TCP/IP protocol stack 113.

Embodiment 4 has been described with respect to a case where transmission data is transmitted from one network processing section to two real-time processing sections. Needless to say, 1:n data communication can also be carried out in the same manner. Further, if data communication, for example, from the real-time processing section A to the network processing section and the real-time processing section B is also performed, the notice signal distribution device may have the function of distributing an interrupt signal from the real-time processing section A to the network processing section and the real-time processing section B.

The virtual network device driver 114 on the transmitting side may execute output of the transmission completion interrupt signal by the transmission completion notice output device 111 (immediately) after the completion of write to the shared memory 301 of transmission data, and thereafter enter a state of awaiting a transmission request from the TCP/IP protocol stack 113, may output the interrupt signal (immediately) before write to the shared memory 301 of transmission data, and enter the transmission request awaiting state after the completion of write to the shared memory 301 of the transmission data, or may output the interrupt signal when a predetermined amount of written data is reached during write to the shared memory 301 of transmission data and enter the transmission request awaiting state after the completion of write to the shared memory 301 of the transmission data, as is that in Embodiment 1. A timer may also be provided in the same manner as in Embodiment 2. Also, the main memory provided in each processing section may be made sharable, as in Embodiment 3.

Also, one memory for storing the TCP/IP protocol stack 113 (first protocol software) and the virtual network device driver 114 (first device driver) or two memories for separately storing the TCP/IP protocol stack 113 and the virtual network device driver 114 may be provided as the first memory device, as in Embodiment 1. Also, one memory for storing the TCP/IP protocol stack 213 (second protocol software) and the virtual network device driver 214 (second device driver) or two memories for separately storing the TCP/IP protocol stack 213 and the virtual network device driver 214 may be provided as the second memory device. In a case where two memories are provided and are each made sharable between the processing sections, one of the two memories may include a shared memory or each of the two memories may include a shared memory.

According to Embodiment 4, as described above, one interrupt notice line connected to the transmission completion notice device (notice signal output device) provided in the processing section on the transmitting side suffices for exclusive control of a shared memory in 1:n communication, and the number of interrupt notice lines through which the transmission completion interrupt signal is transmitted to a number n of processing sections on the receiving side can be reduced to half of that in the conventional multiprocessor system.

According to Embodiment 1, 2, 3, or 4, the need for the operations performed in the conventional multiprocessor: the operation to output a reception completion interrupt signal from, the receiving side to the transmitting side and the operation to detect the reception completion interrupt input from the transmitting side can be eliminated. Therefore the present invention is useful in a multiprocessor system in which high-speed communication is performed between processing sections. The present invention is also useful in a multiprocessor system used for an AV device connected to the Internet or the like, a portable telephone having AV functions, and other devices. Also, the present invention can be applied to use for a robot, an image processing apparatus, an image recognition apparatus or the like connected to a network.

Embodiments 1 to 4 have been described by assuming, for ease of description, that there is only one buffer on the shared memory. However, the same advantage can also be ensured even in a case where a plurality of buffers or a ring buffer is provided.

What is claimed is:

1. A multiprocessor system comprising a processing section for transmitting data, a processing section for receiving data, a shared bus connected between the processing sections, and a shared memory accessed from each processing section via the shared bus, wherein at the time of data communication between the processing sections, the processing section on the transmitting side writes transmission data to the shared memory, the processing section on the receiving side reads out from the shared memory the transmission data, and exclusive control of the shared memory is performed by outputting a notice signal for notifying write to the shared memory of the transmission data, via the shared bus, from the processing section on the transmitting side to the processing section on the receiving side, wherein
the processing section on the transmitting side comprises a notice signal output device for outputting the notice signal to the processing section on the receiving side, and a first memory device for storing a first protocol software capable of execution of data communication between the processing sections and data assurance, and a first device driver software for writing to the shared memory the transmission data received from the first protocol software and for executing output of the notice signal by the notice signal output device, and
the processing section on the receiving side comprises a notice signal input device for inputting the notice signal from the processing section on the transmitting side, and a second memory device for storing a second protocol software capable of execution of data communication between the processing sections and data assurance, and a second device driver software for executing readout from the shared memory of the transmission data after the notice signal has been input by the notice signal input device and for making the second protocol software process the read-out transmitted data, wherein
the shared bus comprises a notice line for transmitting the notice signal therethrough from the processing section on the transmitting side to the processing section on the receiving side at the time of data communication.

2. The multiprocessor system according to claim 1, wherein the first device driver software provided in the processing section on the transmitting side executes output of the notice signal to the processing section on the receiving side by the notice signal output device immediately after the completion of write to the shared memory of the transmission data.

3. The multiprocessor system according to claim 1, wherein the first device driver software provided in the processing section on the transmitting side executes output of the notice signal to the processing section on the receiving side by the notice signal output device immediately before write to the shared memory of the transmission data.

4. The multiprocessor system according to claim 1, wherein the first device driver software provided in the processing section on the transmitting side executes output of the notice signal to the processing section on the receiving side by the notice signal output device when a predetermined amount of written data is reached during write to the shared memory of the transmission data.

5. The multiprocessor system according to claim 1, wherein the processing section on the transmitting side further comprises a timer for notifying timeout after a lapse of a predetermined time period, and the first device driver software provided in the processing section on the transmitting side starts the timer to measure time after the completion of write of the transmission data to the shared memory, and executes write of the next transmission data to the shared memory after receiving the timeout notice from the timer.

6. The multiprocessor system according to claim 1, wherein the shared memory is provided at a position where the speed of access to the shared memory from the processing section on the receiving side is higher than the speed of access to the shared memory from the processing section on the transmitting side.

7. The multiprocessor system according to claim 6, wherein the shared memory is included in the second memory device provided in the processing section on the receiving side or a third memory device provided in the processing section on the receiving side separately from the second memory device.

8. The multiprocessor system according to claim 7, wherein the second device driver software provided in the processing section on the receiving side makes the second protocol software process the transmitted data by designating to the second protocol software a pointer for an area in the second memory device or the third memory device to which the transmitted data has been written, instead of executing readout from the shared memory of the transmitted data and making the second protocol software process the transmitted data read out.

9. The multiprocessor system according to claim 1, wherein transmission data is transmitted from one processing section on the transmitting side to a plurality of processing sections on the receiving side at the time of data communication, the multiprocessor system further comprising a notice signal distribution device for distributing the notice signal to the plurality of processing sections on the receiving side when receiving the notice signal from the processing section on the transmitting side.
